(19) United States
(12) Patent Application Publication
(10) Pub. No.: US 2025/0243590 A1
(43) Pub. Date: Jul. 31, 2025

(54) FRAME FOR PEM ELECTROLYSIS CELLS AND PEM ELECTROLYSIS CELL STACK FOR GENERATING HIGH-PRESSURE HYDROGEN BY MEANS OF DIFFERENTIAL PRESSURE ELECTROLYSIS

(71) Applicant: IGAS ENERGY GMBH, Stolberg (DE)

(72) Inventors: Karl-Heinz Lentz, Stolberg (DE); Elena Borgardt, Stolberg (DE)

(21) Appl. No.: 18/701,383

(22) PCT Filed: Oct. 12, 2022
(86) PCT No.: PCT/EP2022/078404

§ 371 Date: Apr. 15, 2024

(30) Foreign Application Priority Data
Oct. 14, 2021 (EP) 21202604.1
Mar. 17, 2022 (EP) 22162623.7
Apr. 27, 2022 (EP) 22170344.0

(51) Int. Cl. C25B 9/63; C25B 1/04; C25B 9/23; C25B 9/75; C25B 9/77; C25B 11/052

(52) U.S. Cl. CPC C25B 9/63; C25B 1/04; C25B 9/23; C25B 9/75; C25B 9/77; C25B 11/052

(57) ABSTRACT

The invention relates to a novel frame for a PEM electrolysis cell and for a PEM electrolysis cell stack. The subject matter of the invention is the frame, a PEM electrolysis cell and stack-type PEM electrolysis devices, which comprise the frame according to the invention, preassembled components and methods for producing preassembled components and stack-type PEM electrolysis devices. The frame, PEM electrolysis cell and stack-type PEM electrolysis devices according to the invention are suitable for generating high-pressure hydrogen in combination with the use of thin proton exchange membranes. The invention is based on a novel frame- and sealing-concept. The invention also relates to a cover for stack-type PEM electrolysis devices.

The invention relates to a new frame for a PEM electrolytic cell and for a PEM electrolytic cell stack. An object of the invention is the frame, a PEM electrolytic cell and a PEM electrolytic cell stack (=PEM electrolysis device of the stack type) comprising the frame according to the invention, pre-assembled modules, methods for manufacturing the pre-assembled modules and methods for manufacturing the PEM electrolytic cell stacks. The frame according to the invention, the PEM electrolysis cell according to the invention and the PEM electrolytic cell stack according to the invention are suitable for the generation of high-pressure hydrogen by means of differential pressure electrolysis in combination with the use of thin proton exchange membranes. The invention is based on a new frame and seal concept. The invention also relates to a cover for a PEM electrolysis device of the stack type.

Proton exchange membrane (PEM) water electrolysis is an attractive technology for producing hydrogen using electricity from renewable energy sources. This means that the energy in the energy carrier hydrogen can be stored for times when there is not enough electricity available from renewable sources, thereby contributing to decarbonization. An important advantage of PEM electrolysis is the ability to produce hydrogen under pressure. For all potential applications, hydrogen must be available in compressed form, which means that PEM systems (e.g. PEM electrolytic cells and PEM electrolytic cell stacks) are particularly suited to the needs of industry. In order to save energy, it is advantageous to operate PEM electrolysis directly under pressure, as less additional energy is required than with subsequent mechanical compression. As only the hydrogen is usually used, the oxygen can be produced more cheaply without pressure, which is referred to as differential pressure electrolysis. A differential pressure of at least 30 bar is the state of the art today, although this is currently only possible using PEM membranes with a thickness of at least approx. 120 μm.

In order to produce as much hydrogen as possible with the available electricity, the efficiency of the PEM electrolytic cell is of paramount importance. A considerable proportion of the energy loss is caused by ohmic resistance, particularly at the PEM membrane. A catalyst-coated membrane (CCM) is used as the PEM membrane. The membrane resistance can be significantly reduced by using a thin PEM membrane.

The classic structure of a PEM electrolytic cell is shown in FIG. 1.

A classic PEM electrolytic cell consists of a catalyst-coated membrane (CCM) on which the reaction takes place. On the anode and cathode side, porous transport layers (PTL) transport the water towards the CCM, and porous transport layers (PTL) transport the generated gas away from the CCM. The bipolar plate (BPP) spatially separates the anode and cathode sides. The inflow and outflow of gas and water is ensured by a frame made of conventional metal or high-strength plastic (PEEK). The CCM and PTL components are inserted into this frame. The frame is sealed laterally by O-rings or other seals such as flat gaskets or injected seals to prevent the gas from flowing out of the PEM electrolytic cell.

PEM electrolytic cells and PEM electrolytic cell stacks comprising frames are known in the prior art.

U.S. Pat. No. 6,669,826 B1 discloses how to achieve sealing in a PEM electrolytic cell stack by applying uniform contact pressure to the electrolytic cells. In this process, sub-stacks, each comprising a plurality of PEM electrolytic cells arranged in series in a bipolar arrangement, are compressed with the aid of end plates, intermediate supports, tie rods and prestressing means.

U.S. Pat. No. 6,852,441 B1 discloses stabilizing the frames of the PEM electrolytic cells in an electrolytic cell stack by means of a reinforcing element that peripherally surrounds the electrolytic cell stack.

EP 1 356 134 B1 discloses frames for PEM electrolytic cells, wherein the electrolytic cells are compactly stacked in a bipolar arrangement and the stacked frames are separated by partition walls. The frames have two opposing planar surfaces and an opening in which the membrane is held in the frame by thermal pressure bonding on polyphenylene oxide strips, holes for the inlet of electrolyte and as an outlet for the generated gas. The gas and electrolyte are sealed by sealing rings and the stack is sealed by an arrangement of sealing rings in grooves in each frame. To maintain the integrity of the sealing rings between adjacent frames in a stack against the internal pressure, the PEM electrolytic cell stack is enclosed and compressed between two stainless steel plates held together by threaded connecting rods.

U.S. Pat. No. 8,282,811 B2 discloses electrolytic cells for generating hydrogen at high pressures, with frames arranged between the membrane electrode assembly and separators which serve as hydrogen separators or oxygen separators, and which have openings for the flow of water, oxygen and hydrogen. Gaskets seal the frame to the separators, while the membrane seals the frame on the opposite side. Pressure pads between adjacent separators and plastic manifold gaskets surrounding the pressure pads seal the openings between the individual electrolytic cells in a stack.

U.S. Pat. No. 7,507,493 B2 discloses PEM electrolytic cells containing bipolar plates with a seal. The seal is arranged between the frame and an edge of the porous gas diffusion layer. In addition, the electrolytic cells have a protective element between the seal and the membrane electrode arrangement to protect the proton exchange membrane. This should enable the cell to operate at sustained high pressures, low specific resistances and improved creep protection.

U.S. Pat. No. 8,349,151 B2 discloses a frame for use as an anode frame and as a cathode frame in a water electrolyzer, wherein the anode frame and cathode frame are of identical construction and comprise a universal cell frame having a central opening and a plurality of transverse openings, wherein mating sets of transverse openings are spaced about 90 or 180 degrees apart and are each fluidically connected or unconnected to the central opening by at least one internal radial passageway, and wherein the anode frame and cathode frame are rotated 90 degrees relative to each other so that a series of electrolyzers are fluidically interconnected through the openings.

EP 3 462 528 A1 discloses an electrochemical cell for generating high-pressure hydrogen with a membrane electrode arrangement and flow structures with flat surfaces on both sides of the membrane electrode arrangement, one flat surface being larger than the other surface, a bipolar plate, a reinforcing layer and a seal with a sealing ring being arranged between the bipolar plate and the electrolyte membrane next to the flow structure with the smaller surface.

DE 10 2014 010 813 A1 discloses a frame for a stack-type electrolysis device for high-pressure hydrogen production, the frame comprising an integrated reinforcement arranged between the fluid guide and the outer edge and embedded in the frame structure, and a recess arranged radially between the reinforcement and the fluid guide for receiving a seal.

EP 3 699 323 A1 relates to the supply of electrodes of an electrode stack, for example of an electrolyzer.

DE 25 33 728 A1 relates to an electrolytic cell with bipolar electrodes arranged side by side and an outer frame enclosing at least one chamber of the electrolytic cell.

EP 3 770 303 A1 relates to an electrode packing unit for a stack structure of an electrochemical reactor with a bipolar plate, two electrode plates and two current transfer structures arranged between the bipolar plate and the electrode plates.

WO 2020/039218 A1 relates to a stack-type electrolysis device for the electrolysis of water with cathode plate, anode plate, electrolysis stack, end plates and channel sealing arrangements.

US202009906 A1 relates to a catalyst-coated membrane for a water electrolyzer.

Difficulties that typically occur with classic PEM electrolytic cells are
1. Leak tightness problems because in a PEM electrolytic cell stack, i.e. a PEM electrolysis device of the stack type, the frames of many PEM electrolytic cells are stacked on top of each other, and each material used in the frames and other components has manufacturing tolerances. As a result, the O-rings or other seals used may not have sufficient contact pressure at some points on the frame. Especially if the hydrogen is produced under pressure or differential pressure, it is difficult or impossible to achieve a tight seal with the known seals.
2. The mechanical stability of the frame: When high-pressure hydrogen is generated, the plastic frames are deformed (FIG. 2).
3. Between PTL and frame 1 a small gap 17 remains. The CCM 13 is pressed into this gap 17 in compression mode. This results in crawl 24 (so-called viscoelastic behavior) of the CCM 13 into the gap 17. This effect is intensified if the frame 1 is deformed due to low mechanical stability (see point 2), so that the gap 17 becomes larger (FIG. 2).
4. The frame includes channels for the supply and removal of water and gas. The channels are milled out of the frame, i.e. out of the metal or plastic part, which results in high costs.

In order to be able to produce hydrogen under high pressure for industrial purposes using PEM electrolysis, an improved PEM electrolytic cell is required that can be operated under high pressure and differential pressure and that does not have the disadvantages mentioned above.

The problem is solved by the invention according to claims 1 to 21.

Subject of the invention is a frame 1 for a PEM electrolytic cell 2 for a PEM electrolysis device of the stack type 23, the frame 1 comprising a first side 4 having a planar first surface and a second side 5 opposite the first side 4 having a planar second surface and an anode frame 8 and a cathode frame 11, and wherein the anode frame comprises the first side 4, a side opposite the first side 4 of the anode frame 4″ and a first opening 6 for receiving the porous transport layer (PTL) anode 7, wherein the first opening 6 extends from the first side 4 to the opposite side of the anode frame 4″, wherein the cathode frame 11 comprises the second side 5, a side opposite the second side 5 of the cathode frame 5″ and a second opening 9 for receiving the PTL cathode 10, wherein the second opening 9 extends from the second side 5 to the opposite side of the cathode frame 5″, wherein the side opposite the first side 4 of the anode frame 4″ and the side opposite the second side 5 of the cathode frame 5″ are arranged next to each other, wherein anode frame 8 and cathode frame 11 are connected to each other, wherein the first opening 6 and the second opening 9 are connected to each other, wherein the first opening 6 is larger than the second opening 9 and wherein the anode frame 8 and the cathode frame 11 are arranged such that the side opposite the first side 4 of the anode frame 4″ and the side opposite the second side 5 of the cathode frame 5″ form a step 12 at the transition from the anode frame 8 to the cathode frame 11.

In the frame 1 according to the invention, the step 12 preferably is part of the cathode frame 11. In the frame 1 according to the invention, the step 12 preferably adjoins the second opening 9. In the frame 1 according to the invention, the step 12 preferably frames the second opening 9. In the frame 1 according to the invention, the step 12 preferably forms a planar third surface as a support surface for the catalyst-coated membrane (CCM) 13. In the frame 1 according to the invention, the step 12 is preferably part of the cathode frame 11 and forms a planar third surface as a support surface for the membrane 13. In the frame 1 according to the invention, the step 12 is preferably part of the cathode frame 11, which is adjacent to the second opening 9 and frames the second opening 9 and forms a planar third surface as a support surface for the catalyst-coated membrane (CCM) 13.

The anode frame 8 comprises a core 21 and a coating made of sealing material 22. Preferably, the anode frame 8 comprises a core 21 made of metal or another suitable material and preferably, the anode frame 8 comprises a coating made of sealing material 22, wherein the sealing material is preferably rubber (=core 21 with coating made of rubber). The cathode frame 11 comprises a core 21 and a coating made of sealing material 22. Preferably, the cathode frame 11 comprises a core 21 made of metal or another suitable material and a coating made of sealing material 22, the sealing material preferably being rubber (=core 21 with coating made of rubber). Any sealing material is suitable as a coating for a core 21 made of metal, for example rubber, in particular ethylene propylene diene rubber (EPDM). The coating made of sealing material 22 is preferably a seal or acts as a seal in a PEM electrolytic cell 2 or in a PEM electrolysis device of the stack type 23.

Subject of the invention is a frame 1 for a PEM electrolytic cell 2 with a core 21, preferably made of metal, wherein the core 21 is coated with a sealing material, preferably rubber, for example EPDM (FIGS. 3a and 3b). The core 21 of the anode frame 8 is completely or partially coated with sealing material 22, in particular seal. The core 21 of the cathode frame 11 is completely or partially coated with sealing material 22, in particular seal. Any sealing material is suitable as a seal, for example rubber, in particular ethylene propylene diene rubber (EPDM). For example, the seal can comprise EPDM or consist of EPDM.

The core 21 of the anode frame 8 preferably comprises or consists of metal. The core 21 of the cathode frame 11 preferably comprises or consists of metal. A core 21 made of metal provides good mechanical stability. Alternatively, other materials with similar mechanical properties can be used for the core 21. For example, polytetrafluoroethylene (PTFE), in particular reinforced PTFE or molecularly reinforced PTFE. The coating made of sealing material 22, preferably rubber, for example ethylene-propylene-diene rubber (EPDM), creates the sealing effect, i.e. the sealing material acts as a seal.

In preferred embodiments, the entire surface of the core 21 of the anode frame 8 is coated with coating made of sealing material 22. In further preferred embodiments, at least 90%, preferably at least 95% or more of the surface of the core 21 of the anode frame 8 is coated with coating made of sealing material 22. In preferred embodiments, the entire surface of the core 21 of the cathode frame 11 is coated with coating made of sealing material 22. In further preferred embodiments, at least 90%, preferably at least 95% or more of the surface of the core 21 of the cathode frame 11 is coated with coating made of sealing material 22. In these embodiments, the sealing surface is very large.

In alternative embodiments, less than 90% of the surface of the core 21 of the anode frame 8 is coated with coating made of sealing material 22. In further alternative embodiments, less than 90% of the surface of the core 21 of the cathode frame 11 is coated with coating made of sealing material 22. However, in these alternative embodiments, the areas of the surface of the core 21 of the anode frame 8 and/or the core 21 of the cathode frame 11 are coated with coating made of sealing material 22 that are necessary to provide a complete seal of the PEM electrolytic cell 2. Preferably, in these alternative embodiments, at least the areas of the surface of the core 21 of the anode frame 8 and/or the core 21 of the cathode frame 11 that surround the first opening 6 and/or the second opening 9 are coated with coating made of sealing material 22. For example, an area of the surface of the core 21 of the anode frame 8 from 0.5 cm to 2.5 cm, preferably from 1 cm to 2 cm, for example 1.5 cm, which directly surrounds the first opening 6 (see FIGS. 10b to 10d and FIG. 14). For example, an area of the surface of the core 21 of the cathode frame 11 from 0.5 cm to 2.5 cm, preferably from 1 cm to 2 cm, for example 1.5 cm, which directly surrounds the second opening 9.

The metal provides good mechanical stability, whereas the coating made of sealing material 22, preferably rubber, for example EPDM, creates the sealing effect. The fact that preferably the entire or at least 90%, for example at least 95% or more of the surface of the core 21 made of metal of the anode frame 8 or that preferably the entire or at least 90%, for example at least 95% or more of the surface of the core 21 made of metal of the cathode frame 11 is coated with sealing material, preferably rubber, for example EPDM, means that the sealing surface is very large.

A further advantage of a stable core 21, for example made of metal, and the coating made of sealing material 22 is that the components such as PTL anode 7 and PTL cathode 10 can be pressed into the frame 1, in particular into the anode frame 8 and the cathode frame 11 (press fit), and thus in the PEM electrolytic cell 2 or the PEM electrolysis device of the stack type 23 during electrolysis under high pressure or differential pressure, for example electrolysis carried out at a differential pressure of up to 40 bar, there is no deformation of the frame 1 and no formation of a larger gap 17 between individual components inside the frame 1, e.g. between PTL cathode 10 and frame 1 and/or between PTL anode 7 and frame 1 (FIG. 8).

The metal used for the core 21 of anode frame 8 and/or cathode frame 11 can be stainless steel, for example, stainless steel with a thickness of 0.5 mm. The coated core 21 of the anode frame 8, i.e. core 21 and coating made of sealing material 22 together can have a thickness of 1 to 5 mm, preferably 2 to 3 mm, for example 2.2 mm. The coated core 21 of the cathode frame 11, i.e. core 21 and coating made of sealing material 22 together, can have a thickness of 1 to 5 mm, preferably 2 to 3 mm, for example 2.2 mm.

Materials with comparable properties, such as highly reinforced plastic, for example PTFE, molecularly reinforced PTFE, are also suitable for the core 21.

The coating made of sealing material 22 has a layer thickness. The layer thickness of the coating made of sealing material 22 is, for example, 1 to 4.5 mm, for example 2 to 3 mm. Preferably, the layer thickness of the coating made of sealing material 22 surrounding the core 21 of the anode frame 8 is the same everywhere. Preferably, the layer thickness of the coating made of sealing material 22 surrounding the core 21 of the cathode frame 11 is the same everywhere. In particular embodiments, the core 21 of the anode frame 8 has areas that have a reduced layer thickness of the coating made of sealing material 22″ compared to the layer thickness of the coating made of sealing material 22 (FIGS. 10b to 10d, FIG. 14). In particular embodiments, the core 21 of the cathode frame 11 has areas that have a reduced layer thickness of the coating made of sealing material 22 compared to the layer thickness of the coating made of sealing material 22″. For example, the layer thickness of the coating made of sealing material 22″ is reduced by 1 mm compared to the layer thickness of the coating made of sealing material 22 compared to the layer thickness of the coating made of sealing material 22. For example, the layer thickness of the coating made of sealing material 22 is 4 mm and the reduced layer thickness of the coating made of sealing material 22″ is 3 m. For example, the layer thickness of the coating of sealing material 22 is 10 mm or less, preferably 5 mm, 3 mm, 2 mm or less 1.5 mm, 1 mm or less. For example, the reduced thickness of the coating made of sealing material 22 is 9 mm or less, preferably 4 mm, 2.8 mm, 1.9 mm or less 1.45 mm, 0.95 mm or less. For example, the difference in layer thickness between the layer thickness of the coating made of sealing material 22 and the reduced layer thickness of the coating made of sealing material 22″ is 1 mm, 0.7 mm, 0.5 mm or less, for example 0.3 mm, 0.2 mm, 0.1 mm, 0.05 mm or less.

For example, the first opening 6 is at least 0.5 mm or 1 mm, for example 2 mm or more, 0.5 cm, preferably 1 cm, particularly preferably 1.5 cm or more larger than the second opening 9, wherein preferably the step 12, which is formed inside the cathode frame 11 by the larger first opening 6 and the smaller second opening 9, has the same width everywhere (FIG. 7b, FIG. 11). Alternatively, the step 12 can have different widths in various places. The width of the step 12 and thus of the planar third surface for holding the CCM 13 can have the same or different widths in various places.

The anode frame 8 can, for example, have the outer dimensions of 20 to 70 cm by 20 to 70 cm, for example 50 cm by 50 cm or 35 cm by 35 cm. The first opening 6 can, for example, have the dimensions 11 to 51 cm by 11 to 51 cm, for example 21 cm by 21 cm or 15 by 15 cm (FIG. 9b). The cathode frame 11 can, for example, have the outer dimensions of 20 to 70 cm by 20 to 70 cm, for example 50 cm by 50 cm or 35 cm by 35 cm. The second opening 9 can have the dimensions 10 to 50 cm by 10 to 50 cm, for example 20 cm by 20 cm or 14 cm by 14 cm (FIG. 9a). Preferably, the same outer dimensions are selected for anode frame 8 and cathode frame 11. The dimensions for the first opening 6 and the second opening 9 are selected so that the first opening 9 is larger than the second opening 9, so that when anode frame 8 and cathode frame 1 interact as frame 1, a step 12 is formed,

Various frame shapes are known to the skilled person, in which the frame 1, the anode frame 8 and the cathode frame 11 can be designed, for example square, rectangular, round. Due to the fact that the shape of the frame 1 can be freely selected, the contact pressure in certain areas of the frame 1 can be adjusted by increasing or reducing the thickness of the frame, preferably by reducing the thickness of the coating made of sealing material 22. The thickness of the coating made of sealing material 22 can be increased. This allows areas to be created in which the layer thickness of the coating made of sealing material 22 on the core 21 is thicker than in other areas of the anode frame 8 or cathode frame 11. The layer thickness of the coating made of sealing material 22 can be reduced. As a result, areas can be created in which the layer thickness of the coating made of sealing material 22 on the core 21 is less than in other areas of the anode frame 8 or cathode frame 11. Areas with different layer thicknesses of the coating made of sealing material 22 can take over functions in the frame 1 according to the invention.

In order to avoid transverse leaks, the pressure on the active area can be increased, for example, by a circumferential elevation 26″ in the layer thickness of the coating made of sealing material 22, such as a circumferential rubber increase. A circumferential elevation 26″ in the layer thickness of the coating made of sealing material 22 can have a width of 1 mm, for example. The difference in the layer thickness between the coating made of sealing material 22 and the circumferential elevation 26″ can be 1 mm, 0.5 mm, 0.1 mm, 0.05 mm, for example.

Subject of the invention is a frame 1 wherein the coating made of sealing material 22 in certain areas of the anode frame 8 and/or in certain areas of the cathode frame 11 has a reduced layer thickness of the coating made of sealing material 22″ compared to the layer thickness of the coating made of sealing material 22, for example to reduce the contact pressure.

Subject of the invention is a frame 1, wherein the coating made of sealing material 22 has, in certain areas of the anode frame 8, for example to increase the sealing effect, a circumferential elevation 26″ which surrounds the first opening 6. Subject of the invention is a frame 1, wherein the coating made of sealing material 22 in certain areas of the cathode frame 11 has a circumferential elevation 26″ surrounding the second opening 9, for example to increase the sealing effect.

In a square anode frame 8, the first opening 6 can be formed by a first side 27, a second side 28, a third side 29 and a fourth side 30. In a square cathode frame 11, the second opening 9 can be formed by a first side 27″, a second side 28″, a third side 29″ and a fourth side 30″.

Further components that are part of a PEM electrolytic cell 2 or a PEM electrolysis device of the stack type 23 can be saved by installing the components as structures in the frame 1, the anode frame 8, the cathode frame 11, in particular the coating made of sealing material 22 with which the core 21 of the anode frame 8 and the cathode frame 11 are coated. For example, the coating made of sealing material 22 can be a coating made of rubber and comprise a rubber lip 25, which is arranged, for example, in the area of the connections for individual voltage measurements. In this way, the insulating foil can be saved. The invention relates to frames 1 in which the coating made of sealing material 22 of the anode frame 8 and/or the coating made of sealing material 22 of the cathode frame 11 take over further functions in addition to the sealing function. For this purpose, the coating made of sealing material 22 of the anode frame 8 and/or the cathode frame 11 comprises corresponding embodiments, for example a rubber lip 25.

Other required parts can be manufactured directly from the coating made of sealing material 22, so that the number of individual parts required to manufacture a PEM electrolytic cell 2 or a PEM electrolysis device of the stack type 23 is reduced. This significantly reduces the effort required to assemble a PEM electrolysis device of the stack type 23. Likewise, the insertion of means for connecting the anode frame 8 and cathode frame 11 in the anode frame 8 and/or the cathode frame 11, for example pin 19 and hole 18, eliminates the need for an additional assembly aid.

In preferred embodiments, the coating made of sealing material 22 comprises one or more channels type II 15. A channel type II 15 is designed as an area in the coating made of sealing material 22 which has a reduced layer thickness of the coating made of sealing material 22″ compared to the layer thickness of the coating made of sealing material 22. A channel type II 15 is therefore a depression or recess in the coating made of sealing material 22 that does not contribute to the sealing effect. Neighboring individual channels type II 15 are separated by elevations 26. An elevation 26 is, for example, an area between two adjacent channels type II 15, in which the core 21 has a coating made of sealing material 22 that does not have a reduced layer thickness. The reduced layer thickness of the coating made of sealing material 22″ in the area in which individual channels type II 15 are arranged can be selected independently of the reduced layer thickness of the coating made of sealing material 22″ in other areas of the coating surrounding the core 21, which may have a reduced layer thickness of the coating. In particular embodiments, the core 21 has no coating made of sealing material 22 in the one or more areas that represent one or more channels type II 15.

In preferred embodiments, the first opening 6, which is framed by the anode frame 8, and the second opening 9, which is framed by the cathode frame 11, are of different sizes (FIGS. 7b, 8, 9a and 9b). For example, the cathode frame 11 is smaller and the anode frame 8 is larger. This means that at differential pressure, for example a differential pressure of 40 bar, i.e. when only the cathode side of the electrochemical cell 2 is operated under pressure or when only the cathode sides of the PEM electrolysis device of the stack type 23 are operated under pressure, the hydrogen pressure that is generated in the cathode during PEM electrolysis does not or cannot press on the gap 17 between anode frame 8 and PTL anode 7. The CCM 13 is then only pressed against the PTL anode 7 and mechanically supported on the PTL anode 7. Crawl 24 of the CCM 13 into the gap 17 between frame 1, for example anode frame 8 and PTL anode 7, can be prevented in this way.

In preferred embodiments, the frame 1 according to the invention comprises two different types of channels for the supply and removal of water and gas. Preferably, the frame 1 comprises one or more channels type I 14 c for transporting water into the frame 1 and for transporting water and gas out of the frame 1. Preferably, the channels type I 14 are not directly connected to the first opening 6 in the anode frame 8 or the second opening 9 in the cathode frame 11. Preferably, the core 21 of the anode frame 8 comprises one or more channels type I 14. Preferably, the core 21 of the cathode frame 11 comprises one or more channels type I 14. Preferably, the channels type I 14 are coated with coating made of sealing material 22.

Furthermore, the frame 1 preferably comprises one or more channels type II 15 for transporting water into the first opening 6 and for transporting water and oxygen out of the first opening 6 and for transporting hydrogen out of the second opening 9. Preferably, channels type II 15 connect channels type I 14 to the first opening 6. Preferably, channels type II 15 connect channels type I 14 to the second opening 9.

In preferred embodiments, the coating made of sealing material 22 with which the whole or parts of the anode frame 8 are coated comprises one or more channels type II 15. In other embodiments, the core 21 of the anode frame 8 comprises one or more channels type II 15. In preferred embodiments, the coating made of sealing material 22 with which the whole or parts of the cathode frame 11 are coated comprises one or more channels type II 15. In other embodiments, the core 21 of the cathode frame 11 comprises one or more channels type II 15. An advantage of this embodiment is the manufacturing cost. In preferred embodiments, the channels type II 15 are not milled out of each anode frame 8 and each cathode frame 11 but are transferred once into a tool. A suitable tool is, for example, the negative for the anode frame 8 or the negative for the cathode frame 11. For example, the arrangement of the channels type II 15, their diameter, their length and other parameters if applicable are transferred to the tool. The tool can be used to transfer the channels type II 15 into the seal 22, for example as if they were stamped into the sealing material, preferably the rubber, for example EPDM, using a stamp. With the aid of the tool is used to vulcanize the core 21 of the anode frame 8 or the core 21 of the cathode frame 11.

In preferred embodiments, the anode frame 8 comprises on the surface of the first side 4 one or more channels type II 15 which are connected to one or more type I channels 14 and connect the type I channel(s) 14 to the first opening 6 and which, when the frame 1 is installed in a PEM electrolytic cell 2 or a stack type PEM electrolysis device 23, are arranged in the direction towards the bipolar plate (BPP) 16 and wherein the side opposite the first side 4 of the anode frame 4″ has no type II channels 15.

In preferred embodiments, the cathode frame 11 comprised on the surface of the second side 5 one or more channels type II 15 connected to one or more channels type I 14 and connecting the channel(s) type I 14 to the second opening 9 and which, when the frame 1 is installed in a PEM electrolytic cell 2 or a PEM electrolysis device of the stack type 23, are arranged towards the bipolar plate (BPP) 16 and wherein the side of the cathode frame 5″ opposite the second side 5 has no channels type II 15.

In preferred embodiments, the frame 1 according to the invention comprises one or more channels type I 14 for supplying and removing water and gas and one or more channels type II 15, wherein the channel type I 14 is not connected to the first opening 6 in the anode frame 8 or the second opening 9 in the cathode frame 11. In preferred embodiments of the frame 1, the anode frame 8 comprises on the surface of the first side 4 one or more channels type II 15 which are connected to the channel type I 14 and which connect the channel type I 14 to the first opening 6 and which, when the frame 1 is installed in a PEM electrolytic cell 2 or a PEM electrolysis device of the stack type 23, are arranged in the direction towards the BPP 16 and wherein the side of the anode frame 4″ opposite to the first side 4 does not comprise channels type II 15. In preferred embodiments of the frame 1, the cathode frame 11 comprises on the surface of the second side 5 a channel type II 15 which is connected to one or more channels type I 14 and which connect the channel type I 14 to the second opening 9 and which, when the frame 1 is installed in a PEM electrolytic cell 2 or a PEM electrolysis device of the stack type 23, are arranged in the direction towards the BPP 16 and wherein the side of the cathode frame 5″ opposite the second side 5 has no channels type II 15.

In preferred embodiments, the frame 1 according to the invention comprises at least two channels type I 14 for supplying and removing water and gas and at least two channels type II 15, wherein the channels type I 14 are not connected to the first opening 6 in the anode frame 8 or the second opening 9 in the cathode frame 11. In preferred embodiments of the frame 1, the anode frame 8 comprises on the surface of the first side 4 at least two channels type II 15 which are connected to the at least two channels type I 14 and which connect the channels type I 14 to the first opening 6 and which, when the frame 1 is installed in a PEM electrolytic cell 2 or a PEM electrolysis device of the stack type 23, are arranged in the direction towards the BPP 16 and wherein the side of the anode frame 4″ opposite to the first side 4 does not comprise channels type II 15. Preferably, a plurality of channels type II 15 that are arranged on the first side 4 of the anode frame 7 connect one channel type I 14 with the first opening 6. In preferred embodiments of the frame 1, the cathode frame 11 comprises on the surface of the second side 5 at least two channels type II 15 which are connected to at least two channels type I 14 and which connect the channels type I 14 to the second opening 9 and which, when the frame 1 is installed in a PEM electrolytic cell 2 or a PEM electrolysis device of the stack type 23, are arranged in the direction towards the BPP 16 and wherein the side of the cathode frame 5″ opposite to the second side 5 does not comprise any channels type II 15. Preferably, several channels type II 15, which are arranged on the second side 5 of the cathode frame 11, connect a channel type I 14 to the second opening 9.

The channels type II 15, which connect the channels type I 14 with the first opening 6 and the second opening 9, i.e. in a PEM electrolytic cell the PTL anode 7 and the PTL cathode 10 with the channels type I 14 for the supply and removal of water and gas, are arranged in the anode frame 8 and/or in the cathode frame 11 in such a way that they point in the direction of the BPP 16 and not in the direction of the CCM 13. If gas and water flow through the channels type I 14 during electrolysis, the CCM 13 is not affected by this, because the side of the anode frame 7 and the side of the cathode frame 11 on which the CCM 13 rests does not include any channels type II 15, i.e. no channels in the immediate vicinity of the first opening 6 or the second opening 9 in the area in which the CCM 13 is arranged and is exposed to a differential pressure of up to 40 bar during electrolysis. The CCM 13 rests on a smooth flat surface without channels and is therefore well supported even at a differential pressure of up to 40 bar. At the same time, the anode compartment (the anode compartment is formed by anode frame 7, CCM 13 and BPP 16), the cathode compartment (the cathode compartment is formed by cathode frame 11, CCM 13 and BPP 16) and the entire PEM electrolytic cell 2 are completely sealed, even at a differential pressure of up to 40 bar, so that no gas or water can escape.

In exemplary embodiments, the frame 1 comprises two to one thousand or more channels type II 15, for example at least one hundred channels type II 15, preferably at least two hundred channels type II 15, or more or less, for example 50 or less. Preferably, at least half of the channels type I 14 are connected to the first opening 6 or the second opening 9 by means of channels type II 15.

Preferably, at least two or more, for example four, 10 or more channels type II 15 connect a channel type I 14 to the first opening 6. Preferably, at least two or more, for example four, 10 or more channels type II 15 connect a channel type I 14 to the second opening 9.

For example, the channels type II 15, which are connected to the first opening 6, are arranged next to each other on the first side of the frame 4. The distance between two adjacent channels type II 15 is, for example, ≤5 mm, ≤3 mm, preferably ≤2 mm or less. For example, the channels type II 15 between channel type I 14 and first opening 6 are arranged in a fan shape on the first side of the frame 4.

For example, the channels type 1115, which are connected to the second opening 9, are arranged next to each other on the second side of the frame 5. The distance between two adjacent channels type II 15 is, for example, ≤5 mm, ≤3 mm, preferably ≤2 mm or less. For example, the channels type II 15 between channel type I 14 and second opening 9 are arranged in a fan shape on the second side of the frame 5.

The channels of the frame 1 are designed so that the liquid is distributed through the channels type I 14 within a PEM electrolysis device of the stack type 23 and the liquid enters each individual PEM electrolytic cell 2 through channels type II 15. The channels type I 14 are preferably arranged at regular intervals along or parallel to the first opening 6 in the anode frame 8. The channels of type I 14 are preferably arranged at regular intervals along or parallel to the second opening 9 in the cathode frame 11. For example, there are 20 or more or fewer, e.g. five channels type I 14 on each side of a square first opening 6 or on each side of a square second opening 9.

In particularly preferred embodiments, the channels type I 14 are arranged in such a way that they each supply the same portion and thus the same area of the first opening 6 and the second opening 9 of an electrochemical cell 2 or the first openings 6 and the second openings 9 of a PEM electrolysis device of the stack type 23 with water.

In particularly preferred embodiments, continuous channels type II 15 with preferably constant opening diameters of preferably 5 mm or less, particularly preferably <2 mm, lead from each channel type I 14 or a part of the channels type I 14 to the first openings 6 or to the second openings 9. These channels type II 15 are arranged in a fan shape, for example, so that the channels type II 15 are evenly distributed over the first openings 6 or second openings 9. Other arrangements of the channels type II 15 in the area between the first opening 6 or the second opening and the channel type I 14, which passes through the channels type II 15, are possible. By limiting the width of the channels type II 15 to 5 mm or less, preferably two mm or less, sufficient contact pressure is transmitted to the opposite frame 1 in the area of the channels type II 15.

The uniform distribution of the channels type I 14 and type II 15 over the entire width of the frame 1 along the first opening 6 or along the second opening 9, for example along the entire width of the first side of the first opening 27 and along the entire width of the third side of the first opening 29 (FIG. 10a) leads to a particularly good distribution of the water over the entire active cell area (=first opening 6+second opening 9) of the electrochemical cell 2. Water flows evenly through the PEM electrolytic cell 2. Since a large proportion of the incoming water is used for cooling, an even distribution of the channels type II 15 leads to a homogeneous heat dissipation. This arrangement of channels type II 15 allows the heat generated during PEM electrolysis to be dissipated evenly. The dissipation of the reaction heat is a critical parameter for a PEM electrolytic cell 2 or a PEM electrolysis device of the stack type 23.

According to the invention, PEM electrolysis devices of stack type 23 with different designs and structures are included.

Included are frames 1, PEM electrolytic cells 2, pre-assembled modules 20 and PEM electrolytic devices of the stack type 23 in which the individual channels type II 15 are adapted to provide a higher or lower pressure drop in the flow of the water compared to the other channels type II 15 of the respective frame 1, the respective electrochemical cell 2, the respective PEM electrolytic device of the stack type 23. For example, the external channels type II 15 are adapted accordingly, i.e., for example, the channels type II 15 located at the edge of the arrangement of the channels type II 15 on the first side of the frame 4, e.g. the channels type II 15 arranged at the edge of the arrangement of the channels type II 15 with respect to the first side of the first opening 27 are adapted such that either a higher or a lower pressure loss of the water flowing through is produced compared to the other channels type II 15 of the frame 1, the electrochemical cell 2, the pre-assembled module 20, the PEM electrolysis device of the stack type 23. This can be achieved, for example, by reducing the opening cross-section of the channels type II 15. This is necessary, for example, if the pressure loss in the channels type I 14 is not uniform, and if the channels type II 15 are uniform, then certain areas of the active cell area (active cell area=first opening 6+second opening 9) with a higher volume flow of water flowing through the channels type II 15 in question, which are connected to the channels type I 14 in which the flowing water has a higher pressure. Without an adaptation of the channels type II 15, the cooling in the active cell area could then become more uneven, for example, due to the water flowing through. This can be compensated for by adapting the channels type II 15. The cross-sections of the relevant channels type II 15 can, for example, be adapted, e.g. reduced, in order to compensate for the differences in water pressure in the channels type I 14. Preferably, a uniform or homogeneous water pressure is generated over the entire active cell area. With channels type II 15, which are e.g. individually adapted, which e.g. have different opening cross-sections, the different pressure loss in the channels type I 14 can be compensated and the flow through all channels type II 15 can be homogenized.

According to the invention are frames 1, PEM electrolytic cells 2, pre-assembled modules 20 and PEM electrolytic devices of the stack type 23 are comprised, in which the individual channels type II 15 of the relevant frame 1, the relevant electrochemical cell 2, the relevant pre-assembled module 20, the relevant PEM electrolytic device of the stack type 23 are arranged such that each channel type II 15 supplies water to an area of the same size of the active cell area.

According to the invention are frames 1, PEM electrolytic cells 2, pre-assembled modules 20 and PEM electrolysis devices of stack type 23 are comprised, wherein the individual channels type II 15 of the respective frame 1, the respective PEM electrolytic cell 2, the respective pre-assembled module 20, the respective PEM electrolysis device of the stack type 23 are designed such that all channels type II 15 can transport the same amount of water in the same time, i.e. all channels type II 15 are the same. This can be achieved, for example, by the fact that all channels type II 15 have the same cross-section through which water can flow. Preferably, the channels type II 15 are arranged in such a way that each channel type II 15 supplies water to an area of the same size of the active cell area. Particularly preferably, the channels type II 15 are arranged in such a way that each channel type II 15 supplies an area of the same size of the active cell area with water and all channels type II 15 are the same. In this way, the entire active cell area can be evenly supplied with water.

The number, shape and arrangement of channels type I 14 and other parameters relating to channels type I 14 and the number, shape and arrangement of channels type II 15 and other parameters relating to channels type II 15 can be adapted as required, e.g. to the frame shape used.

In the frame 1 according to the invention, anode frame 8 and cathode frame 11 are connected to each other via connecting elements. Corresponding connecting elements are known to the person skilled in the art. In preferred embodiments of the frame 1, the anode frame 8 comprises one or more connecting elements, for example pins 19, and the cathode frame 11 comprises one or more connecting elements, for example holes 18, wherein the pin or pins 19 and the hole or holes 18 are arranged such that the hole or holes 18 in the cathode frame 11 can be plugged onto the pin or pins 19 in the anode frame 8 and the anode frame 8 and cathode frame 11 can thereby be connected to one another.

Subject of the invention is a PEM electrolytic cell 2 for operation under differential pressure of up to 40 bar for generating high-pressure hydrogen, comprising a PEM membrane electrode arrangement with CCM 13, a PTL anode 7, a PTL cathode 10, wherein the PEM electrolytic cell 2 comprises a frame 1 according to the invention, wherein the first opening 6 in the anode frame 8 comprises the PTL anode 7 and the second opening 9 in the cathode frame 11 comprises the PTL cathode 10 and wherein the CCM 13 is arranged between the side opposite the first side 4 of the anode frame 4″ and the side opposite the second side 5 of the cathode frame 5″, wherein one side of the CCM 13 rests on the PTL anode 7 and the other side of the CCM 13 rests on the step 12 and the PTL cathode 10 (FIGS. 7b and 7c). When the PEM electrolytic cell 2 is operated under differential pressure, the differential pressure does not act on the CCM 13 in the area of the gap 17 between the anode frame 8 and PTL anode 7. This prevents the CCM 13 from crawling 24 into the gap 7 (FIGS. 8 and 8a).

In preferred embodiments, the PEM electrolytic cell 2 according to the invention comprises a CCM 13 having a thickness of less than 80 μm, for example a CCM 13 having a thickness of 50 μm or less.

In the PEM electrolytic cell 2 according to the invention, the coatings made of sealing material 22, for example the coating made of rubber, preferably the coating made of EPDM of the anode frame 8, the coatings made of sealing material 22, for example the coating made of rubber, preferably the coating made of EPDM of the cathode frame 11 and the step 12 interact with the CCM 13 (FIGS. 7c and 8a) and completely seal the PEM electrolytic cell 2 and the anode compartment and the cathode compartment without the crawl 24 of the CCM 13 into the gap 17 between the anode frame 8 and the PTL anode 7. The special arrangement of the channels type II 15 fully ensures both the supply and removal of water and gas as well as the stability of the CCM 13 and a complete sealing of the PEM electrolytic cell 2. The frame 1 according to the invention therefore enables the use of CCMs 13 with a thickness of less than 80 μm, for example with a thickness of 50 μm or less (=thin CCM 13). With the frame 1 according to the invention, PEM electrolytic cells 2 can be produced with a thinner CCM 13 than usual in the prior art. In addition, these PEM electrolytic cells 2 can be operated in such a way that the hydrogen is accumulated to generate a differential pressure on the cathode side of up to 40 bar without damaging the CCM 13 or causing the PEM electrolytic cell 2 to leak.

In preferred embodiments, the anode 7 is designed such that the BPP 16 is connected to the anode 7, this is referred to as BPP/anode 36 according to the invention. The use of BPP/anode 36 not only facilitates assembly, but also reduces the contact resistance between the individual parts. In preferred embodiments, the anode 7 comprises at least one coarse distributor and at least one fine distributor for the process media, in particular the water. The coarse distributor distributes the water efficiently over the entire cell area (i.e. the first opening and the second opening 6+9). The fine distributor transports the water to the CCM 13, enables good electrical contact with the CCM 13 and at the same time supports the CCM 13 mechanically. An expanded metal, for example, can be used as a coarse distributor for the PTL anode 7. A plate made of sintered powder, for example, can be used as the fine distributor for the PTL anode 7. Coarse distributor and fine distributor, for example expanded metal and sintered metal, can be joined together, for example by resistance welding, to produce a PTL anode 7. Alternatively, the powder can be sintered directly onto the expanded metal to produce a PTL anode 7. The PTL anode 7 can be connected to the BPP 16. Preferably, the BPP 16 consists of the same material as the PTL anode 7. In particularly preferred embodiments, the BPP 16 and PTL anode 7 consist of titanium. In alternative preferred embodiments, BPP 16 and PTL anode 7 comprise at least 80% of the same material, e.g. titanium. The connection between BPP 16 and PTL anode 7 can be realized, for example, by resistance welding, preferably at several points. In the BPP/PTL anode 36, the surface of the BPP 16 corresponds to the outer surface of the frame 1 or the surface of the BPP/PTL anode 36 essentially corresponds to the outer surface of the frame 1. The surface of the PTL anode 7 in the BPP/PTL anode 36 is adapted so that it fills the first opening 6 or fits into the first opening 6. Instead of two parts (BPP 16 and PTL anode 7), only one part, the BPP/PTL anode 36, is required for assembly. This means that one part is saved.

Depending on whether water or gas is transported via the electrode, the channels type I 14 on one side or two sides along the first opening 6 of the anode frame 8 can also be significantly smaller than the channels type I 14 on other sides along the first opening of the anode frame 8 (see FIG. 10b). For example, the channels type I 14 on the cathode side can be significantly smaller than on the anode side (see FIGS. 10b to 10d). To save space and ensure the mechanical stability of the frame 1, channels type I 14 can be designed as a slot instead of a round hole, for example. Different shapes and a corresponding adaptation are possible for the channels type I 14.

Subject of the invention is a pre-assembled module 20 for manufacturing an electrolysis device of the stack type 23 comprising a frame 1 according to the invention. An object of the invention is, for example, a pre-assembled module 20 for producing an electrolysis device of the stack type 23 comprising an anode frame 8, a cathode frame 11, a BPP 16, a PTL anode 7 and a PTL cathode 10,
wherein the anode frame 8 comprises a first side 4 of the frame 1 with a planar first surface, a side opposite the first side 4 of the anode frame 4″ and a first opening 6 for receiving the PTL anode 7, wherein the first opening 6 extends from the first side 4 to the opposite side of the first side 4 of the anode frame 4″, and wherein the first opening 6 is surrounded by the anode frame 8, and wherein the anode frame 8 comprises at least one connecting element for connection to the cathode frame 11, for example a pin 19, wherein the cathode frame 11 comprises a second side 5 of the frame 1 with a planar second surface, a side opposite the first side 5 of the cathode frame 5″ and a second opening 9 for receiving the PTL cathode 10, wherein the second opening 9 extends from the second side 5 to the opposite side of the second side 5 of the cathode frame 5″ and is surrounded by the cathode frame 10, and wherein the cathode frame 11 comprises at least one connecting element for connection to the anode frame 8, for example a hole 18 for receiving the pin 19 of the anode frame 8,
wherein the BPP 16 is arranged between the first side 4 of the frame 1 and the second side 5 of the frame 1, wherein the BPP 16 can be part of a BPP/PTL anode 36, wherein the anode frame 8 comprises a core 21, which for example consists of metal or comprises metal, and a coating made of sealing material 22, for example a coating made of rubber, preferably a coating made of EPDM, and wherein the core 21 is completely or partially coated with coating made of sealing material 22, and wherein preferably the BPP 16 is connected to the PTL anode 7 to form a BPP/PTL anode 36 and the PTL anode 7 or the BPP/PTL anode 36 is inserted or pressed into the first opening 6 and the PTL anode 7 is framed by the anode frame 8,
the cathode frame 10 comprises a core 21, which for example consists of metal or comprises metal, and a coating made of sealing material 22, for example a coating made of rubber, preferably a coating made of EPDM, and wherein the core 21 is completely or partially coated with coating made of sealing material 22, and wherein the PTL cathode 10 is inserted or pressed into the second opening 9 and framed by the cathode frame 11, wherein the anode frame 8 and the cathode frame 11 are connected via the connecting elements of the anode frame 8 and the cathode frame 11, for example the pin 19 of the anode frame 8 is inserted into the hole 18 of the cathode frame 11 and the anode frame 8 and cathode frame 11 are thereby connected to one another,
wherein the first opening 6 is larger than the second opening 9 and wherein the anode frame 8 and the cathode frame 11 are arranged such that the first side 4 and the second side 5 form a step 12 at the transition from the anode frame 8 to the cathode frame 11, wherein preferably the step 12 is the part of the cathode frame 11 which preferably adjoins the second opening 9 and preferably frames the second opening 9 and wherein the step 12 preferably forms a planar third surface as a support surface for the CCM 13, wherein the BPP 16 or the BPP 16 of the BPP/PTL anode 36 rests on one side on the PTL anode 7 and the anode frame 8 and rests on the other side on the PTL cathode 10, the cathode frame 11 and the step 12. The pre-assembled module 20 preferably comprises the channels type I 14 and type II 15 described in this application for the supply and removal of water and gas, which can be arranged as described.

Subject of the invention is a method for manufacturing a pre-assembled module 20 comprising a frame 1 according to the invention. Subject of the invention is, for example, a method for manufacturing a pre-assembled module 20, comprising the method steps
a) a core 21, preferably made of metal, is produced for the anode frame 8, the core 21 comprising a first side 4 with a planar first surface and a side opposite the first side 4 of the anode frame 4″, the first side 4 and the side opposite the first side 4 of the anode frame 4″ comprising a first opening 6, which extends from the first side 4 to the side opposite the first side 4 of the anode frame 4″ and which is framed by the anode frame 8, and comprises one, two or more channels of type I 14 for the supply and removal of water and gas, wherein the channel or channels of type I 14 are not connected to the first opening 6 in the anode frame 8, and wherein the anode frame 8 comprises at least one connecting element for connection to the cathode frame 11, e.g. a pin 19,
b) the surface of the core 21 produced according to a) for the anode frame 8 is completely or partially, for example at least 90% of the surface of the core 21 produced according to a) for the anode frame 8 for producing a coating made of rubber as a coating made of sealing material 22 by vulcanization is coated with natural or synthetic rubber and is then vulcanized, and a coating made of rubber is thereby produced on the entire surface or on parts of the surface of the core 21, preferably a coating made of EPDM, wherein in the coating made of rubber one, two or more channels of type II 15 are produced on the surface of the first side 4, which are connected to one, two or more channels of type I 14 and which connect the channel or channels of type I 14 with the first opening 6 and which, when the anode frame 8 is installed in a PEM electrolytic cell 2 or a PEM electrolysis device of the stack type 23, are arranged in the direction of the BPP 16 or the BPP side of the BPP/PTL anode 36 and wherein in the coating made of rubber on the side opposite the first side 4 of the anode frame 4″ no channels of type II 15 are produced,
c) the PTL anode 7 and the BPP 16 or a BPP/PTL anode 36 are placed or pressed into the anode frame 8 produced according to a) and b),
d) a core 21, preferably made of metal, is produced for the cathode frame 11, the core 21 comprising a second side 5 with a planar second surface and a side opposite the second side 5 of the cathode frame 5″, the second side 5 and the side opposite the second side 5 of the cathode frame 5″ comprising a second opening 9 which extends from the second side 5 to the side opposite the second side 5 of the cathode frame 5″ and which is framed by the cathode frame 11, and comprises one, two or more channels of type I 14 for the supply and removal of water and gas, wherein the channel or channels of type I 14 are not connected to the second opening 9 in the cathode frame 11, and wherein the cathode frame 11 comprises at least one connecting element for connection to the anode frame 8, e.g. a hole 18,
e) the surface of the core 21 for the cathode frame 11 produced according to d) is completely or partially, for example at least 90% of the surface of the core 21 produced according to d) for the cathode frame 11 for producing a coating made of rubber as a coating made of sealing material 22 by vulcanization is coated with natural or synthetic rubber and is then vulcanized, and a coating made of rubber is thereby produced on the entire surface or on parts of the surface of the core 21, preferably a coating made of EPDM, wherein in the coating made of rubber one, two or more channels of type II 15 are produced on the surface of the second side 5, which are connected to one, two or more channels of type I 14, and which connect the channel or channels of type I 14 with the second opening 9 and which, when the cathode frame 11 is installed in a PEM electrolytic cell 2 or a PEM electrolysis device of the stack type 23, are arranged in the direction of the BPP 16 or the BPP side of the BPP/PTL anode 36, and wherein in the coating made of rubber on the side opposite the second side 5 of the cathode frame 5″ no channels of type II 15 are produced,
f) the cathode frame 11 produced according to d) and e) is connected to the anode frame 8, for example by the cathode frame 11 being plugged onto the anode frame 8 and the BPP 16 being arranged between the first side 4 and the second side 5 and then the PTL cathode 10 being inserted or pressed into the cathode frame 11.

Subject of the invention is a method for manufacturing a PEM electrolysis device of the stack type 23 for operation under differential pressure for generating high-pressure hydrogen, comprising frames 1 according to the invention, pre-assembled modules 20 according to the invention, electrochemical cells 2. Subject of the invention is, for example, a method for manufacturing a PEM electrolysis device of the stack type 23 for operation under differential pressure for generating high-pressure hydrogen, comprising the method steps,
a) at least x pre-assembled modules 20 according to the invention and at least x+1 CCMs 13 are stacked alternately one above the other, wherein a stack of pre-assembled modules 3 is produced, wherein in the stack of pre-assembled modules 3 one pre-assembled module 20 and one CCM 13 are stacked alternately on top of each other, and one CCM 13 is arranged on the top side and one on the bottom side of the stack of pre-assembled modules 3 and one CCM 13 is arranged between each two adjacent pre-assembled modules 20, and wherein
b) then a single anode, preferably a single PTL anode 7′, is arranged parallel to an outer CCM 13 on one side of the stack of pre-assembled modules 3 and a single cathode, preferably a single PTL cathode 10′, is arranged parallel to an outer CCM 13 on the other side of the stack of pre-assembled modules 3,
c) an end plate 33 is arranged parallel to the single anode and parallel to the single cathode, and the stack produced is then compressed between the two end plates 33 to form a PEM electrolytic device of the stack type 23, wherein x is an integer and ≥2.

In preferred embodiments of a method of manufacturing the PEM electrolysis device of the stack type 23 according to the invention, one or more, preferably each, of the x+1 CCMs 13 in the PEM electrolysis device of the stack type 23 has a thickness of less than 80 μm, wherein x is an integer and >2. Particularly preferably, a plurality of, preferably each of, the x+1 CCMs 13 in the PEM electrolysis device of the stack type 23 have a thickness of less than 50 μm or less, wherein x is an integer and ≥2.

Subject of the invention is a PEM electrolysis device of the stack type 23 for operation under differential pressure for generating high-pressure hydrogen, comprising one or more frames 1 according to the invention. Subject of the invention is a PEM electrolysis device of the stack type 23 comprising one or more pre-assembled modules 20 according to the invention. Subject of the invention is a PEM electrolysis device of the stack type 23 comprising one or more PEM electrolytic cells 2 according to the invention.

Subject of the invention is, for example, a PEM electrolysis device of the stack type 23 for operation under differential pressure for generating high-pressure hydrogen, comprising x pre-assembled modules 20 according to the invention, x+1 CCMs 13, a single anode, a single cathode and two end plates 33, wherein the x pre-assembled modules 20 and the x+1 CCMs 13 are stacked alternately one above the other to form a stack of pre-assembled modules 3, wherein one pre-assembled module 20 and one CCM 13 are alternately stacked one above the other in the stack of pre-assembled modules 3 and wherein one CCM 13 is arranged on the upper side and one on the lower side of the stack of pre-assembled modules 3 and one CCM 13 is arranged between two adjacent pre-assembled modules 20, and wherein a single anode, preferably a single PTL anode 7′, is arranged parallel to an outer CCM 13 on one side of the stack of pre-assembled modules 3 and a single cathode, preferably a single PTL cathode 10′, is arranged parallel to an outer CCM 13 on the other side of the stack of pre-assembled modules 3,
wherein one end plate 33 is arranged parallel to the single anode and one end plate 33 is arranged parallel to the single cathode, and the generated stack is compressed between the two end plates 33 to form a PEM electrolytic device of the stack type 23, wherein x is an integer and ≥2.

In preferred embodiments of the PEM electrolysis device of the stack type 23 according to the invention, one or more, preferably each, of the x+1 CCMs 13 in the PEM electrolysis device of the stack type 23 has a thickness of less than 80 μm, preferably a thickness of less than 50 μm or less, wherein x is an integer and ≥2.

Depending on requirements, further components can be installed in the PEM electrolysis device of the stack type 23 at the appropriate locations, for example an insulating plate 32 can be installed between CCM 13 and end plate 33. Insulating plates 32 at these locations prevent, for example, the end plates 33 from being short-circuited, e.g. when screws are used. Corresponding components are known to the person skilled in the art. The skilled person can adapt the method of manufacturing accordingly.

Subject of the invention is a PEM electrolysis device of the stack type 23 for operation under differential pressure for generating high-pressure hydrogen, comprising x pre-assembled modules 20 according to the invention, x+1 CCMs 13, a single anode, preferably a single PTL anode 7′, a single cathode, preferably a single PTL cathode 10′, and two end plates 33, wherein the x pre-assembled modules 20 and the x+1 CCMs 13 being stacked alternately one above the other to form a stack of pre-assembled modules 3, wherein in the stack of pre-assembled modules 3 one pre-assembled module 20 and one CCM 13 are stacked alternately one above the other and wherein in each case one CCM 13 is arranged on the upper side and the lower side of the stack of pre-assembled modules 3 and in each case one CCM 13 is arranged between two adjacent pre-assembled modules 20, and wherein a single anode is arranged parallel to an outer CCM 13 on one side of the stack of pre-assembled modules 3 and a single cathode is arranged parallel to an outer CCM 13 on the other side of the stack of pre-assembled modules 3, wherein an end plate 33 is arranged parallel to the single anode and parallel to the single cathode, respectively, and the generated stack is compressed between the two end plates 33 to form a PEM electrolytic device of the stack type 23, wherein x is an integer and ≥2.

A half-cell anode comprises only the anode side of an electrochemical cell 2, not the cathode side of the electrochemical cell 2. In preferred embodiments, a half-cell anode comprises a single anode 7′ and an anode frame 8. In preferred embodiments, a half-cell anode consists of a single anode 7′ and an anode frame 8. A half-cell anode completes an electrochemical cell 2 in a pre-assembled module 20 or a stack of pre-assembled modules 3.

A half-cell cathode comprises only the cathode side of an electrochemical cell 2, not the anode side of the electrochemical cell 2. In preferred embodiments, a half-cell cathode comprises a single cathode 10′ and a cathode frame 11. In preferred embodiments, a half-cell cathode consists of a single cathode 10′ and a cathode frame 8. A half-cell cathode completes an electrochemical cell 2 in a pre-assembled module 20 or a stack of pre-assembled modules 3.

In preferred embodiments, the PEM electrolysis device of the stack type 23 comprises at least 2 or 3 or 5 or more, for example 10, 50, 100, 500, 1000 or more pre-assembled modules 20 according to the invention. Preferably, the PEM electrolysis device of the stack type 23 according to the invention comprises, in addition to a number of x pre-assembled modules 20 according to the invention, wherein x is an integer and ≥2, a cathode frame 11, a CCM 13, an anode frame 8 and two end plates 33. Preferably, in the PEM electrolysis device of the stack type 23 according to the invention, the first and the last PEM electrolytic cell 2 are different from those that lie in between. For example, to produce a PEM electrolysis device of the stack type 23, a CCM 13 is arranged on a cathode frame 11, x pre-assembled modules 20 and x CCMs 13 are alternately stacked on the CCM 13, and an anode frame 8 is stacked thereon. The stack is compressed between end plates 33 to form a PEM electrolysis device of the stack type 23, wherein x is an integer and ≥2.

In the PEM electrolysis device of the stack type 23, preferably one of the two end plates 33 is an upper end plate 38, which for example is arranged at the top in a PEM electrolysis device of the stack type 23. In the PEM electrolysis device of the stack type 23, preferably one of the two end plates 33 is a lower end plate 44, which is for example arranged at the bottom in a PEM electrolysis device of the stack type 23.

A PEM electrolysis device of the stack type 23 is operated as a flow reactor in electrolysis mode. Water is continuously fed into the PEM electrolysis device of the stack type 23 and water is discharged from the PEM electrolytic cell of stack type 23. Water must be distributed from the water connection for the introduction of water (=water connection input) 39 of the PEM electrolysis device of the stack type 23 to the channels type I 14. At the same time, water must be routed from the channels type I 14 to the water connection for the discharge of water (=water connection outlet) 40. This requires space which may not be available on the end plate 33, for example because the end plate 33 then becomes too thick and if the end plate 33 becomes too thick, the PEM electrolysis device of the stack type 23 becomes too heavy.

Subject of the invention is a lid 37 for a PEM electrolysis device of the stack type 23. The lid 37 according to the invention has a construction in which as much space as possible is created for water without making the entire end plate 33 unnecessarily thick.

Subject of the invention is a lid 37 for a PEM electrolysis device of the stack type 23, wherein the end plate 33, for example the upper end plate 38, comprises at least one water connection for the introduction of the water 39, at least one water connection for the discharge of the water 40 and at least two distributor covers 41, wherein the upper end plate 38 to create space for water has at least two spaces for the distribution of water in the end plate 42, and wherein each of the at least two distributor covers 41 has space for the distribution of water in the distributor cover 43, and wherein at least one distributor cover 43 for the introduction of water into the PEM electrolysis device of the stack type 23 is connected to at least one water connection for the introduction of water 39 and a space for the distribution of water in the end plate 42, and wherein at least one further distributor cover 43 for the discharge of water from the PEM electrolysis device of the stack type 23 is connected to at least one water connection for the discharge of water 40 and a space for the distribution of water in the end plate 42.

Subject of the invention is a PEM electrolysis device of the stack type 23 comprising the lid 37 according to the invention. Subject of the invention is a PEM electrolysis device of the stack type 23 according to the invention, which comprises the lid 37 according to the invention.

In order to completely seal the individual frames 1 of electrochemical cells 2 and the individual frames 1 of a PEM electrolysis device of the stack type 23, especially at high pressures or high differential pressures, the end plates 33 or the upper end plate 38 and the lower end plate 44 must be tensioned with a sufficient bolt force or contact pressure. The coating made of sealing material 22 then acts as a seal and completely seals the individual frames 1, anode frame 8 and cathode frame 11. If frames 1 with large frame surfaces are used, the contact pressure required to clamp the end plates 33 so that they are completely sealed is even higher. For frames 1 with a large frame area, if the core 21 of the anode frame and the core 21 of the cathode frame are completely coated with coating made of sealing material 22, the contact pressure is particularly high, i.e. with a large area of coating made of sealing material 22 on the first side 4 of the anode frame 8, and with a large first opening 6, i.e. with a long first side of the first opening 27 and possibly a long second side of the first opening 28. A large frame area means, for example, 1600 cm² or more. In preferred embodiments, not the entire frame surface of the anode frame 8 is necessary for the seal. In certain embodiments, not the entire frame surface of the cathode frame 11 is necessary for the seal. In order to reduce the contact pressure, the thickness of the coating made of sealing material 22 can be reduced in the areas of the surface of the core 21 that are not required for the seal. Corresponding anode frames 8 or cathode frames 11 comprise areas on the core 21 in which the coating made of sealing material 22 has a layer thickness and areas on the core 21 in which the coating made of sealing material 22″ has a reduced layer thickness compared to the layer thickness of the coating made of sealing material 22 (FIG. 10b, FIG. 14), e.g. the layer thickness of the coating made of sealing material 22″ in the area of the surface of the core 21 which is not required for sealing is 0.05 mm or more, for example 0.1 mm, preferably 0.2 mm or more less than the layer thickness of the coating made of sealing material 22 in the area of the surface of the core 21 which is required for sealing the active area (active area=first and second opening 6+9) and the channels type I and type II 14+15. In order to reduce the contact pressure, the thickness of the coating made of sealing material 22 can be reduced in the areas of the surface of the core 21 for the cathode frame 11 or the anode frame 8, which is not necessary for the seal, e.g. the area of the surface of the core 21 which is not required for sealing has a layer thickness of the coating made of sealing material 22″ reduced by 0.05 mm or more, for example 0.1 mm, preferably 0.2 mm or more, for example in the areas of the surface of the core 21 which is not necessary for sealing the active area (first and second opening 6+9) and the channels type I and type II 14+15.

The area of the surface of the core 21 of the anode frame 8 and/or the cathode frame 11 in which the coating made of sealing material 22 is not reduced in thickness is primarily subjected to pressure when the PEM electrolysis device of the stack type 23 is clamped (FIGS. 1, 10 to 15 MPa). The sealing area in which the coating made of sealing material 22 on the surface of the core 21 has a non-reduced layer thickness can be defined, for example, such that the area of the surface of the core 21 which is arranged at a distance of 0.2 mm or more, for example 0.5 mm or 1 mm or more, preferably 1.5 mm or 2 mm or more around the first inner opening 6 or the second inner opening 9 and around the channels type I 14 and the channels type II 15 (FIG. 10b, FIG. 14). The distance can vary. The distance to the first opening 6, the second opening 9, to the arrangement of the channels type I 14, to the channels type II 15, in which the coating made of sealing material 22 has a non-reduced layer thickness, can be the same or different. In particular embodiments, the coating made of sealing material 22 can have a layer thickness of zero in the area of the surface or in parts of the area of the surface of the core 21 of the anode frame 8 or the cathode frame 11 in which the coating made of sealing material 22″ has a reduced layer thickness, i.e. in particular embodiments in this area of the surface the core 21 is not coated with a coating made of sealing material 22″. By reducing the layer thickness of the coating made of sealing material 22″ in certain areas of the surface of the core 21 of the anode frame 8 or the cathode frame 11, the area that has to be compressed can be reduced by 50%, for example, compared to a coating made of sealing material 22 that coats the surface of the core 21 completely with the same layer thickness. This also reduces the contact pressure required to press the frames 1 in the PEM electrolysis device of the stack type 23 by up to 50%.

A further advantage of advantageous embodiments of the invention are the manufacturing costs. The channels type II 15 are not milled out of each anode frame 8 and each cathode frame 11 but are transferred once into a tool. One tool is the negative for the anode frame 8, another tool is the negative for the cathode frame 11. The channels type II 15 are transferred into the tool and are virtually inserted into the coating made of sealing material 22, preferably rubber, for example EPDM, like a stamp. With the aid of the tool, the metal core 21 is coated with the sealing material, preferably rubber, for example EPDM, by vulcanization, wherein the channels type II 15 are simultaneously produced in the desired areas of the anode frame 8 and/or the cathode frame 11 according to the invention. The molded parts or rubber molded parts produced by vulcanization of anode frame 8 and/or cathode frame 11 can be used directly and can be produced in large quantities at low cost. Alternative processes are known, for example injection molding or 3D printing.

The PEM electrolysis device of the stack type 23 is preferably designed in such a way that all components have a smooth and homogeneous surface so that no voltage peaks occur on the CCM 13. In order to prevent the CCM 13 from crawling 24 into the pores of the PTL anode 7 and/or the PTL cathode 10 under gas pressure, PTL anodes 7 and/or PTL cathodes 10 with a pore diameter <0.1 mm are used, for example. For example, PTLs with a so-called ‘microporous layer’, i.e. a particularly homogeneous surface, can be used as PTL anode 7 and/or PTL cathode 10.

Preferably, the PEM electrolysis device of the stack type 23 according to the invention is used for the electrolysis of water in the temperature range from 10 to 95 degrees Celsius, preferably in the temperature range from 40 to 80 degrees Celsius, particularly preferably in the temperature range from 68 to 72 degrees Celsius. The PEM electrolysis device of the stack type 23 according to the invention also has the advantage that the temperature difference from one side of the stack to the other side of the stack is preferably maximum 0 to 10 degrees Celsius, preferably maximum 3 to 7 degrees Celsius, in particular maximum 4 degrees Celsius.

The anode frame 8 and the cathode frame 11 can easily be joined together to form a pre-assembled module 20, since the sealing and anode frame 8 or sealing and cathode frame 11 each consist of one component. Preferably, a BPP 16 connected to a PTL anode 7, i.e. a BPP/anode 36, is used to produce a pre-assembled module 20. For example, BPP 16 and PTL anode 7 are welded together, so that BPP 16 and PTL anode 7 are present as one component BPP/PTL anode 36. To produce the pre-assembled module 20, the anode frame 8 is first inserted or pressed onto the anode 7 or the PTL anode 7 of the BPP/PTL anode 36. For example, in addition to a first pin 19 as a means for connection to the cathode frame 11, the anode frame 8 can also have a second pin 19 as a means for connection to the BPP 16 or the BPP/PTL anode 36, which can be inserted into the BPP 16. For this purpose, the BPP 16 or the BPP 16 of the BPP/PTL anode 36 comprises a corresponding means for connection to the anode frame 8, preferably a hole 18. The anode frame 8 with the inserted or pressed-in PTL anode 7 and the BPP 16 or the BPP/PTL anode 36 is then turned over and the cathode frame 11 can also be inserted on the other side of the anode frame 8 with means for connection to the anode frame, preferably a hole 18, and thereby connected to the anode frame 8. The PTL cathode 10 is then inserted or pressed into the cathode frame 11 (FIG. 6). A pre-assembled module 20 is obtained. Pre-assembled module 20 can then be stacked alternately with CCMs 13 via centering pins, for example, in order to produce stacks of pre-assembled modules 3 or PEM electrolysis devices of stack type 23.

### REFERENCE SIGNS

| | |
|---|---|
| Frame | 1 |
| PEM electrolytic cell | 2 |
| Stack of pre-assembled modules 20 | 3 |
| First side of frame 1 | 4 |
| The side opposite the first side 4 of the anode frame 8 | 4″ |
| Second side of frame 1 | 5 |
| The side opposite the second side 5 of the cathode frame 11 | 5″ |
| First opening | 6 |
| Porous transport layer (PTL) anode | 7 |
| Single PTL anode | 7′ |
| Anode frame | 8 |
| Second opening | 9 |
| Porous transport layer (PTL) cathode | 10 |
| Single PTL cathode | 10′ |
| Cathode frame | 11 |
| Step | 12 |
| Catalyst-coated membrane (CCM) | 13 |
| Channel type I | 14 |
| Channel type II | 15 |
| Bipolar plate (BPP) | 16 |
| Gap | 17 |
| Hole | 18 |
| Pin | 19 |
| Pre-assembled module | 20 |
| Core | 21 |
| Coating made of sealing material | 22 |
| Reduced layer thickness of the coating made of sealing material | 22″ |
| 22 | |
| PEM electrolysis device of the stack type | 23 |
| Crawl | 24 |
| Rubber lip | 25 |
| Elevation between two channels type II 15 | 26 |
| Circumferential elevation 26 to increase the sealing effect | 26″ |
| around the active area | |
| First side of the first opening 6 of the anode frame 8 | 27 |
| First side of the second opening 9 of the cathode frame 11 | 27′ |
| Second side of the first opening 6 of the anode frame 8 | 28 |
| Second side of the second opening 9 of the cathode frame 11 | 28′ |
| Third side of the first opening 6 of the anode frame 8 | 29 |
| Third side of the second opening 9 of the cathode frame 11 | 29′ |
| Fourth side of the first opening 6 of the anode frame 8 | 30 |
| Fourth side of the second opening 9 of the cathode frame 11 | 30′ |
| Edge of channel type I 14 | 31 |
| Insulating panel | 32 |
| End plate | 33 |
| Tie rod | 34 |
| Current collector plate | 35 |
| BPP 16 and PTL anode 7 are connected (=BPP/PTL anode) | 36 |
| Lid for a PEM electrolysis device of the stack type 23 | 37 |
| Upper end plate | 38 |
| Water connection for introduction of water (=water connection | 39 |
| input) | |
| Water connection for discharge of water (=water connection | 40 |
| outlet) | |
| Distributor cover | 41 |
| Space for water distribution in the upper end plate 38 | 42 |
| Space for water distribution in the distributor cover | 43 |
| Lower end plate | 44 |

### FIGURES

FIG. 1: Classical structure of a PEM electrolytic cell from the state of the art with frame 1, catalyst-coated membrane (CCM) 13, bipolar plate (BPP) 16, PTL anode 7, 5 PTL cathode 10 with gap 17 between frame 1 and PTL anode 7 and frame 1 and PTL cathode 10. The frame 1 comprises channels type I 14 for the supply and removal of water and gas.

FIG. 2: Frame 1 according to FIG. 1 with deformation of the frame 1 and formation of a larger gap 17 between frame 1 and PTL anode 7 and frame 1 and PTL cathode 10 and crawl 24 of the CCM 13 into the enlarged gap 17 between frame 1 and PTL anode 7 and frame 1 and PTL cathode 10.

FIG. 3a: Shown is a part of the frame 1 according to the invention, which comprises a core 21 coated with a coating made of sealing material 22 and which comprises a channel type II 15 in the coating made of sealing material 22.

FIG. 3b: A part of the frame 1 according to the invention is shown. The frame 1 comprises a core 21 coated with a coating made of sealing material 22 and a part of a channel type II 15 in the coating made of sealing material 22.

FIG. 4: The cathode frame 11 according to the invention shown here has a second opening 9 which is framed by a first side 27′, a second side 28′, a third side 29′ and a fourth side 30′ of the cathode frame 11. The cathode frame 11 comprises two holes 18 as connecting element for connection to the anode frame 8 and twenty channels type I 14. The cathode frame 11 comprises several channels type II 15 on the second side 5, which connect the second opening 9 with ten channels type I 14, each channel type I 14 being connected to the second opening 9 by means of several channels type II 15. On the side opposite the second side 5 of the cathode frame 5″, there are no channels type II 15 that connect the channels type I 14 with the second opening 9.

FIG. 5: The anode frame 8 according to the invention shown here has a first opening 6, which is framed by a first side 27, a second side 28, a third side 29 and a fourth side 30 of the anode frame 8. The anode frame 8 comprises two pins 19 as connecting element for connection to the cathode frame 11 and, in this specific example, also twenty channels of type I 14, which are arranged such that, when the anode frame 8 and the cathode frame 11 are connected, they can interact with the twenty channels of type I 14 of the cathode frame 11 for the supply and removal of water and gas. The anode frame 8 comprises channels type II 15 on the first side 4, which connect the first opening 6 with ten channels type I 14. On the side opposite the first side 4 of the anode frame 4″, there are no channels type II 15 that connect the channels type I 14 with the first opening 6. The anode frame 8 comprises a coating made of sealing material 22, preferably rubber. This anode frame 8 comprises a lip made of sealing material, preferably a rubber lip 25.

FIG. 6 schematically shows the method for manufacturing a pre-assembled module 20 with the method steps a) Initial position: PTL anode 7 and BPP 16 are connected (BPP/PTL anode 36); b) 1st step: the pins 19 of the anode frame 8 are inserted into the holes 19 of the BPP/PTL anode 36; c) 2nd step: turning over the arrangement from b), the BPP 16 side of the BPP/PTL anode 36 can be seen; d) 3rd step: the cathode frame 11 is inserted into the arrangement. e) Step 4: the PTL cathode 10 is inserted into the second opening 9.

FIG. 7: shows an exploded view of a pre-assembled module 20. The parts that are comprised in the pre-assembled module 20 can be seen: Cathode frame 11, anode frame 8, BPP/PTL anode 36, PTL cathode 10 and the arrangement of cathode frame 11, anode frame 8, BPP/PTL anode 36, and PTL cathode 10 in the pre-assembled module 20. A sequence in which the individual parts are preferably assembled is also shown. The type II channels 15 in the cathode frame 11 are arranged on the side opposite the visible side of the cathode frame 11. This is the second side of the frame 5. They are not visible from this perspective. Their arrangement on the second side of the frame 5 is marked in light grey on the side opposite the second side of the cathode frame 5″.

FIG. 7a: shows a pre-assembled module 20 in plan view. All 4 parts belonging to the pre-assembled module 20 can be seen: Cathode frame 11, anode frame 8, BPP/PTL anode (36) and PTL cathode 10. The channels type II 15 are all arranged in the direction towards the BPP/PTL anode 36 and are therefore not visible in the pre-assembled module 20, because they are arranged inside the pre-assembled module 20. The arrangement of the channels type II 15 inside the module 20 is shown in light grey on the visible side of the cathode frame 11 (=the side of the frame opposite the second side of the cathode frame=5″).

FIG. 7b: shows a side view of a pre-assembled module 20. Anode frame 8 and cathode frame 11 are connected. The PTL anode 7 is inserted into the anode frame 8 and the PTL cathode 10 is inserted into the cathode frame 11. The BPP 16 is located between anode frame 8 and cathode frame 11. Anode frame 8 and cathode frame 11 form a step 12 because the first opening 6 is larger than the second opening 9. The BPP 16 is arranged on the PTL cathode 10, the step 12 and the cathode frame 11 and rests with its other side on the PTL anode 7 and the anode frame 8.

FIG. 7c: shows an enlarged section of a part of the pre-assembled module 20 from FIG. 7b, which clearly shows the step 12.

FIG. 8: Shown is a section of a schematic structure of PEM electrolysis device of the stack type according to the invention, namely a stack of pre-assembled modules 3. The arrangement shows a stack with three PEM electrolytic cells 2. The arrows show the direction of the gas pressure during high-pressure hydrogen electrolysis, which is carried out under a differential pressure of 40 bar.

FIG. 8a: Enlarged section of a part of a PEM electrolytic cell 2 with the step 12. The arrows indicate the direction from which the increased pressure acts on the CCM 13 at differential pressure.

FIG. 9a: Exemplary dimensions for a cathode frame 11. The channels type II 15 connect the second opening 9 with the channels type I 14, which are arranged along the second side of the second opening 28′ and along the fourth side of the second opening 30′. In each case, several channels type II 15 connect the second opening 9 with a channel type I 14. The individual channels type II 15 are separated from one another by elevations 26.

FIG. 9b: Exemplary dimensions for an anode frame 8 matching the cathode frame 11 shown in FIG. 9a. The channels type II 15 connect the first opening 6 with the channels type I 14, which are arranged along the first side of the first opening 27 and along the third side of the first opening 29. In each case, several channels type II 15 connect the first opening 6 with a channel type I 14. The individual channels type II 15 are separated from one another by elevations 26.

FIG. 10a: Shown is an embodiment of an anode frame 8. The anode frame 8 comprises channels type I 14 and channels type II 15, wherein the channels type II 14 are arranged in a fan shape on the first side of the frame 4. In this embodiment, the anode frame 8 is quadrangular and comprises a quadrangular first opening 6 and twenty channels type I 14, wherein five of the channels type I 14 are arranged in each of the four sides of the anode frame, i.e. the first side of the first opening 27 comprises five channels type I 14, the second side of the first opening 28 comprises five channels type I 14, the third side of the first opening 29 comprises five channels type I 14 and the fourth side of the first opening 30 comprises five channels type I 14. In two opposite sides of the anode frame 8, the five channels type II 14 are each connected to eight channels type II 15. Each channel type II 15 is connected to a channel type I 14 and to the first opening 6. The channels type II 15 are arranged in a fan shape on the first side of the frame 4 and are evenly spaced along the first side of the first opening 27 and the third side of the first opening 29.

FIG. 10b: An anode frame 8 is shown. The anode frame 8 comprises channels type I 14, wherein a part of the channels type I 14 has a round shape and a part of the channels type I 14 has an oval shape. The anode frame 8 comprises a coating made of sealing material 22 arranged on the core 21 (the core is not shown) of the anode frame 8. The coating made of sealing material 22 has a layer thickness, which is shown as a bordered area. The line surrounding the bordered area is a circumferential elevation 26 to increase the sealing effect around the active area 26″. The area of the anode frame 8 surrounding the channels type I 14 and the channels type II 15 and the first opening 6 is coated with coating made of sealing material 22 in the layer thickness. The thickness of the coating made of sealing material 22 on the core 21 in this area of the anode frame 8 is 1.2 mm. The remaining part of the core 21 of the anode frame 6 (shown outside the border and labeled with 22′) has a reduced layer thickness of the coating made of sealing material 22″ compared to the layer thickness of the coating made of sealing material 22. The reduced layer thickness of the coating made of sealing material 22″ on the core 21 in this area of the anode frame 8 is 0.3 mm.

FIG. 10c: The anode frame 8 is shown in an oblique side view. This shows the channels type II 15, which are designed as depressions in the coating made of sealing material 22, which has a defined layer thickness in this area of the anode frame 8. Individual adjacent channels of type II 15 are separated by elevations (=area with a coating made of sealing material 22 with a defined layer thickness).

FIG. 10d shows a section of the anode frame 8 from FIG. 10c.

FIG. 10e: A cathode frame 11 is shown. The cathode frame 11 comprises channels of type I 14, some of the channels of type I 14 having a round shape and some of the channels of type I 14 having an oval shape. The oval channels type I 14 are connected to the second opening 9 via channels type II 15. The cathode frame 11 comprises a rubber lip 25 for isolating the single voltage measurement. An anode frame 8 could have an analogous arrangement.

FIG. 11 shows an embodiment of a pre-assembled module 20 (shown without PTL cathode 10 and without CCM 13) comprising cathode frame 11 and anode frame 8. The step 12 is formed by the different size of the first opening 6 and the second opening 9. On a part of step 12 channels type II 15 are arranged, which are only partially visible because they are covered by the cathode frame 11.

FIG. 12 shows a PEM electrolysis device of the stack type 23 according to the invention with stacks of PEM electrolytic cells 2, insulating plates 32, end plates 33, tie rods 34 and current collector plate 35.

FIG. 13 shows a preferred embodiment of the PTL anode 7, wherein the BPP 16 is connected to the anode 7 to form a BPP/PTL anode 36.

FIG. 14 shows the pressure distribution in a PEM electrolytic cell 2 according to the invention with an anode frame 8 as shown in FIG. 10b. The cell was tightened between two end plates 33 with a defined torque. Between the anode frame 8 and a matching cathode frame 11, a pressure-sensitive foil, which triggers differently at different pressures, was arranged instead of the CCM 13. By evaluating the pressure-sensitive foil, it was determined in which area of the anode frame 8 which pressure prevails. The highest pressure of 10 to 15 MPa is in the area of the anode frame 8 in which the core 21 is coated with coating made of sealing material 22, i.e., for example, along the first side of the first opening 27 and along the second side of the first opening 29 and in the area around the channels type I 14. This region of the anode frame 8 has a layer thickness which is 0.2 mm thicker than the region with reduced layer thickness of the coating made of sealing material 22″. The region in which the channels type II 15 which connect the first opening 6 to the channels type I 14 and the elevations 26 are arranged is excluded from this. In this area, the pressure is only 1 to 2 MPa. The area at the outer edge of the anode frame 8, where the core 21 is coated with a layer thickness that is reduced in comparison to the coating made of sealing material 22 (=reduced layer thickness of the coating made of sealing material 22″), has an even lower pressure of 0.1 to 0.5 MPa.

FIG. 15a shows the lid 37 according to the invention for a PEM electrolysis device of the stack type 23. The lid 37 comprises an end plate 33, for example an upper end plate 38, which is connected to two distributor covers 41, wherein one distributor cover 41 comprises a water connection for the input 39 and another distributor cover 41 comprises a water connection for the outlet 40.

FIG. 15b shows the lid 37 for a PEM electrolysis device of the stack type 23 with a distributor cover 41 removed so that the water distribution space in the end plate 42 and the type I channels 14 connected to the water distribution space in the end plate 42 are visible in the end plate 33.

FIG. 15c shows a distributor cover 41 for the lid 37 according to the invention for a PEM electrolysis device of the stack type 23, wherein the space for water distribution in the distributor cover 43 is visible.

FIG. 15d shows a diagram with a simulation of how the water is distributed in the lid 37 according to the invention. The diagram also shows the different flow velocities at different points of the lid 37 and in the area of the transition to the channels type I 14.

FIG. 16 shows an anode frame 7 with arrangement of channels type I 14 and type II 15 as well as areas with coating made of sealing material 22 and areas with coating made of sealing material 22″ with reduced layer thickness. The channels type II 15 connect a part of the channels type I 14 with the first opening 6. They are arranged along the first side of the first opening 27 and along the third side of the first opening 29 at regular intervals, so that each channel type II 15 introduces water or discharges water and gas into the same area of the first opening 6 or the active area.

FIG. 16a to c show enlarged sections of the anode frame from FIG. 16.

FIG. 17 shows a cathode frame 11 with arrangement of channels type I 14 and type II 15 as well as areas with coating made of sealing material 22 and areas with coating made of sealing material 22″ with reduced layer thickness. The channels type II 15 connect a part of the channels type I 14 with the second opening 9. They are arranged along the second side of the second opening 28′ and along the fourth side of the second opening 30′ at regular intervals, so that each channel type II 15 introduces water or discharges water and gas into the same area of the first opening 6 or the active area.

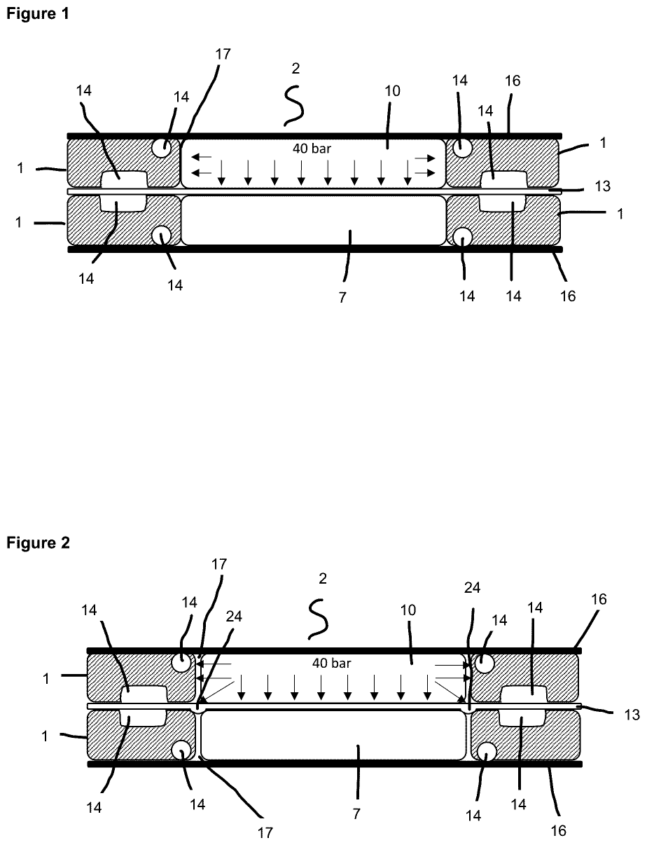

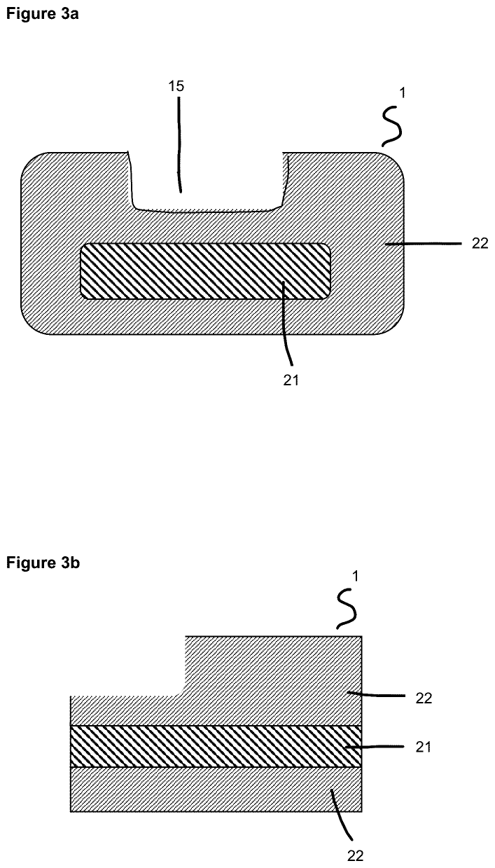

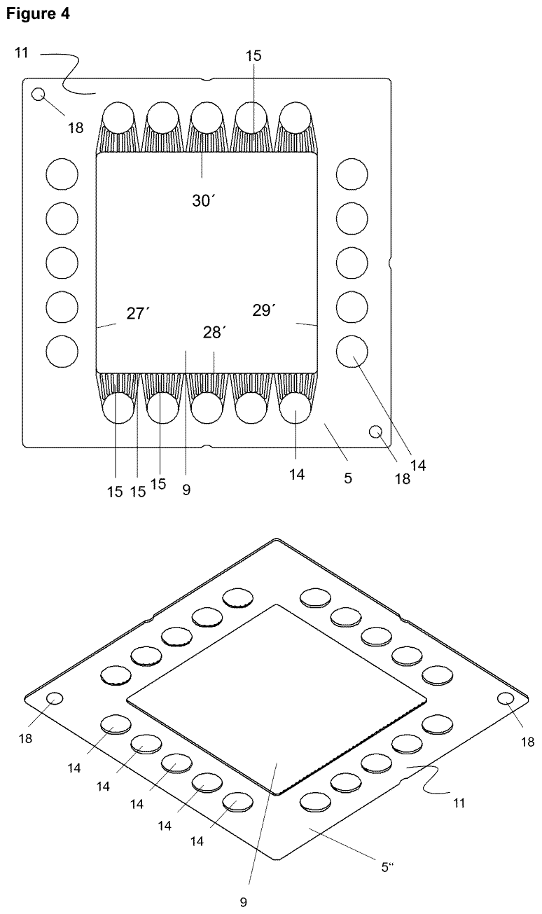

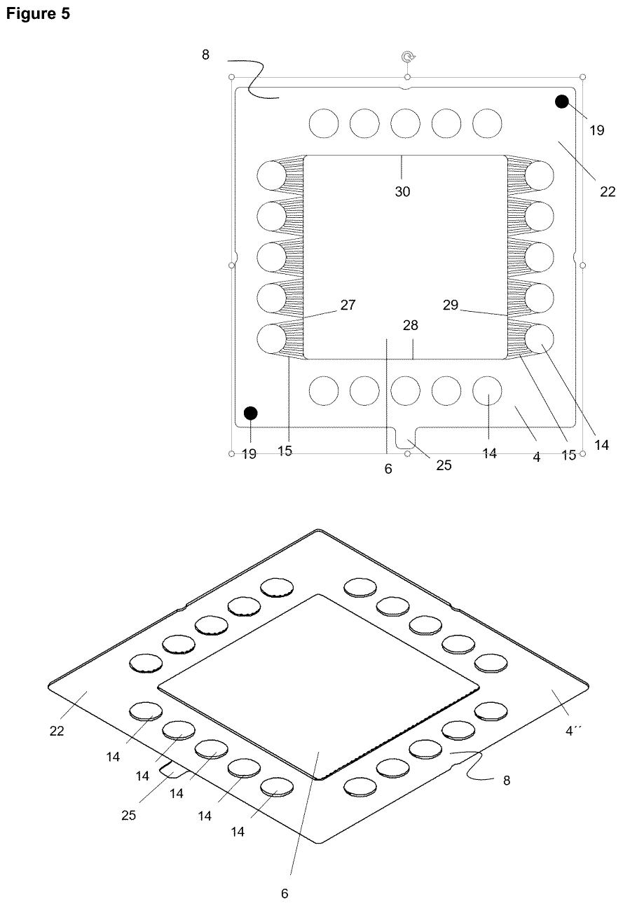

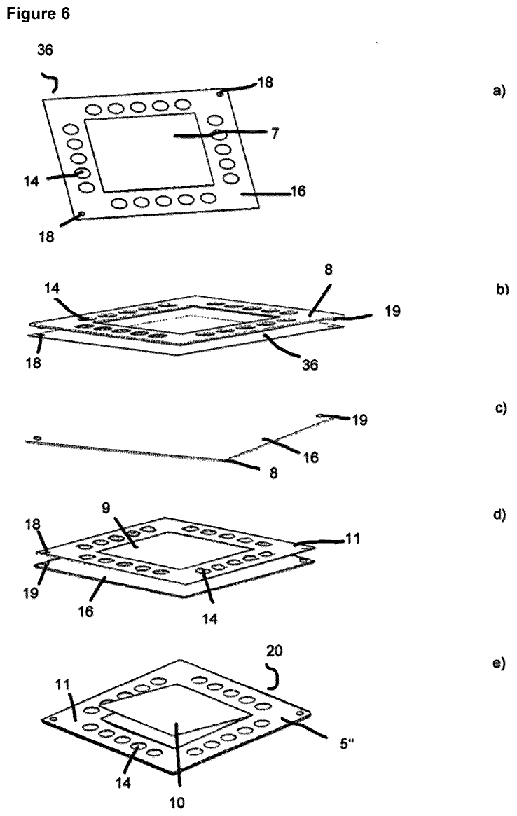

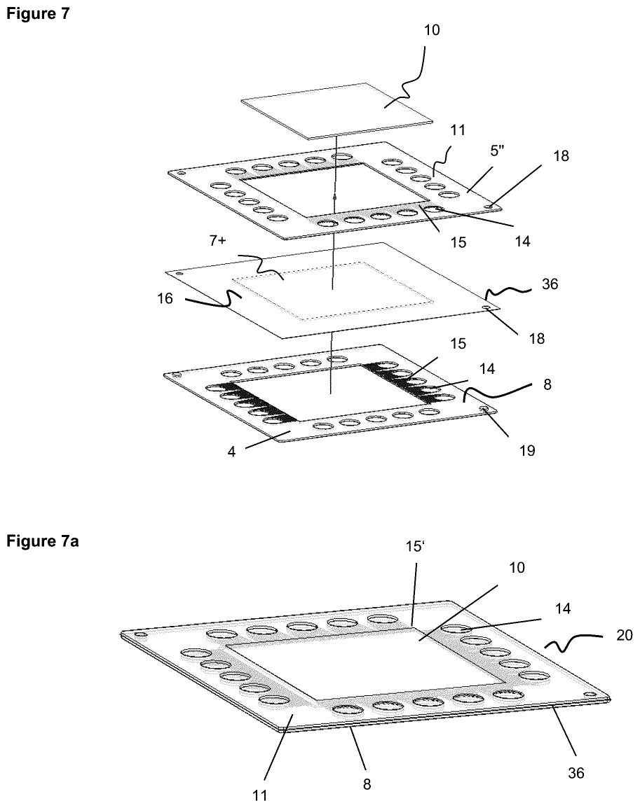

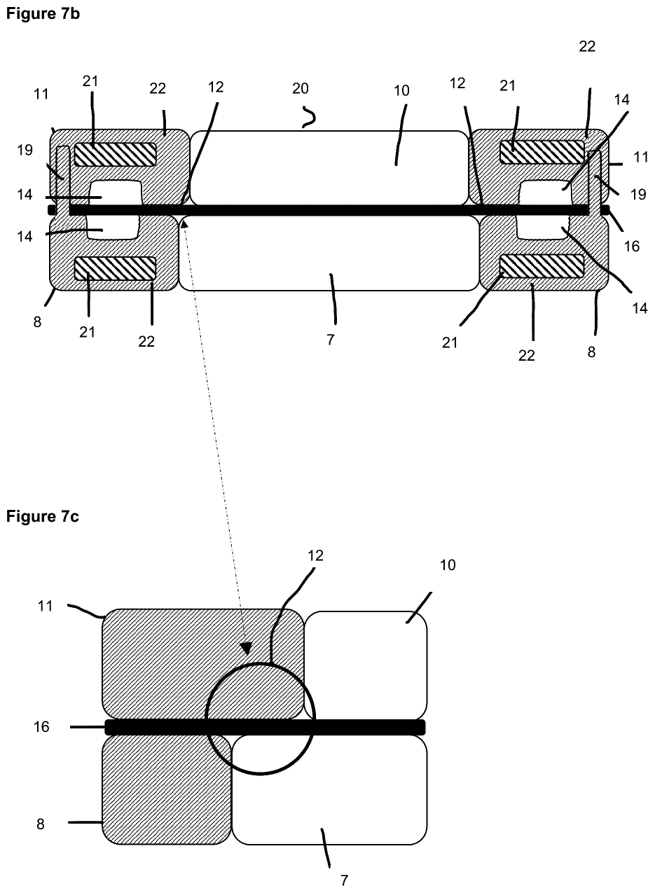

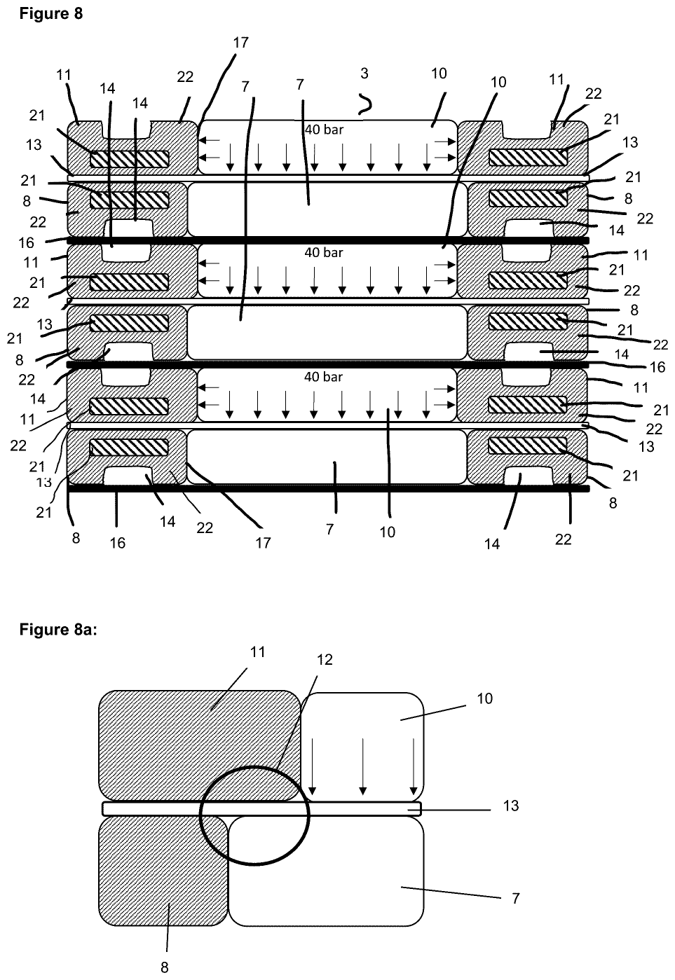

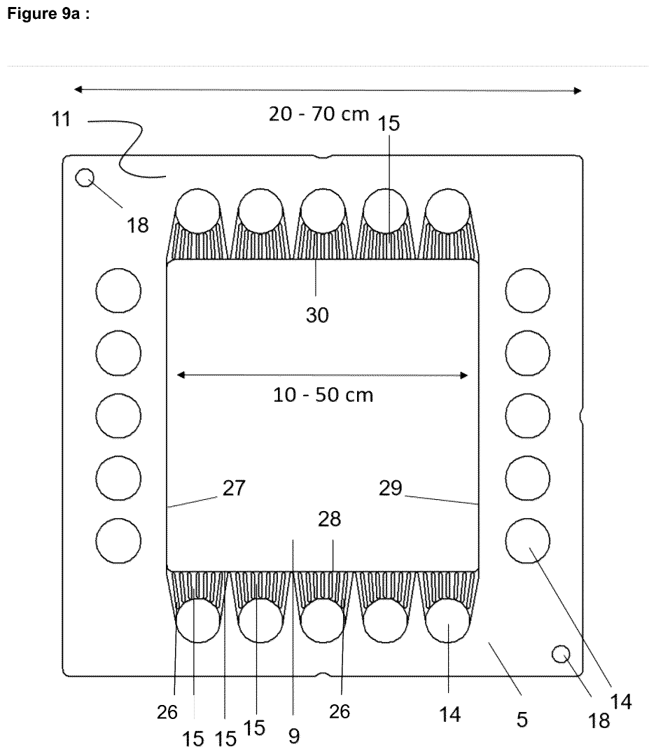

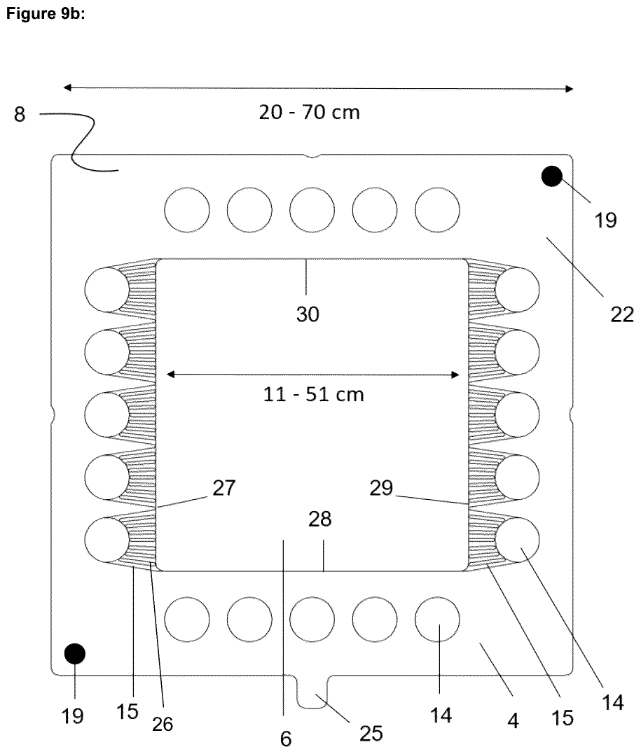

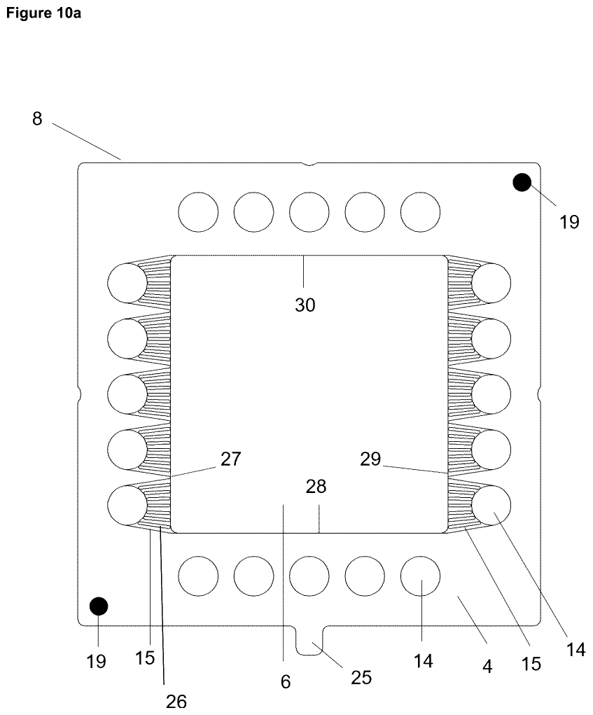

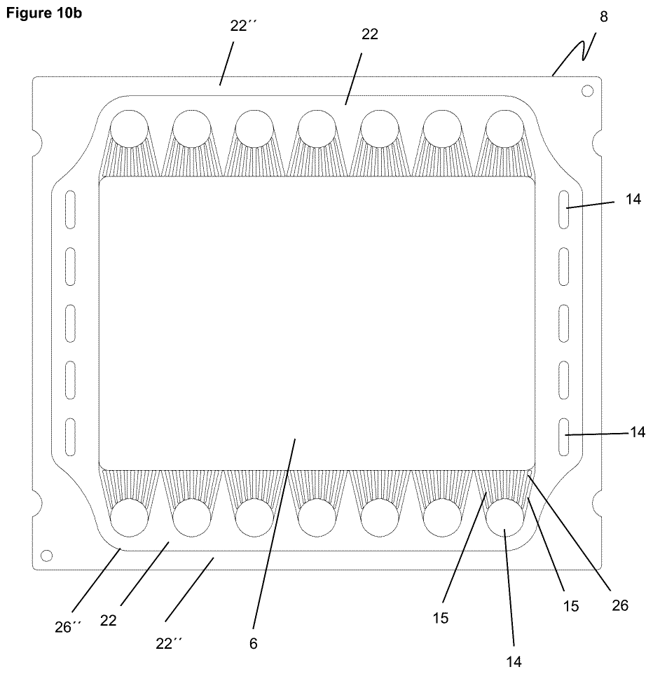

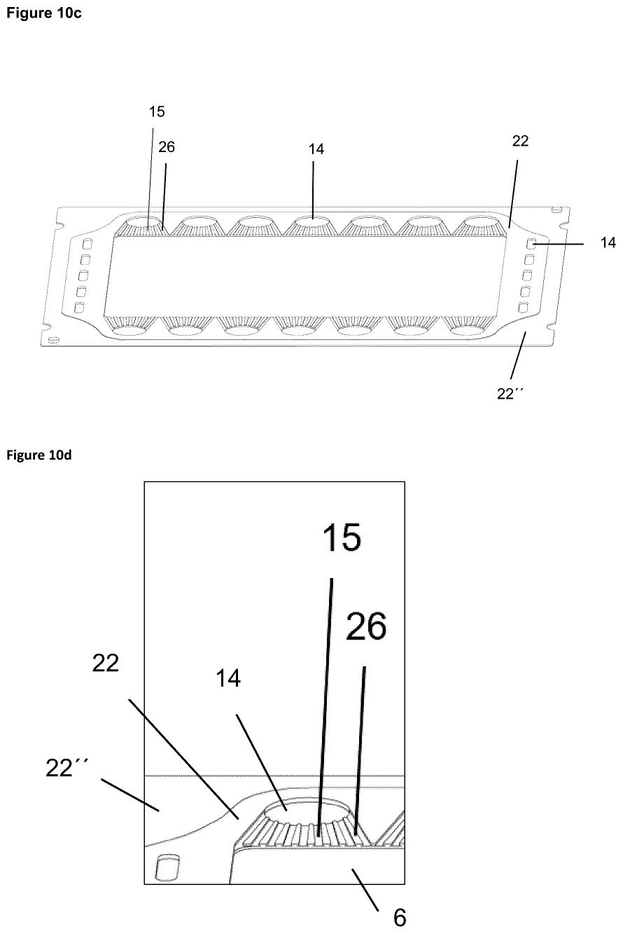

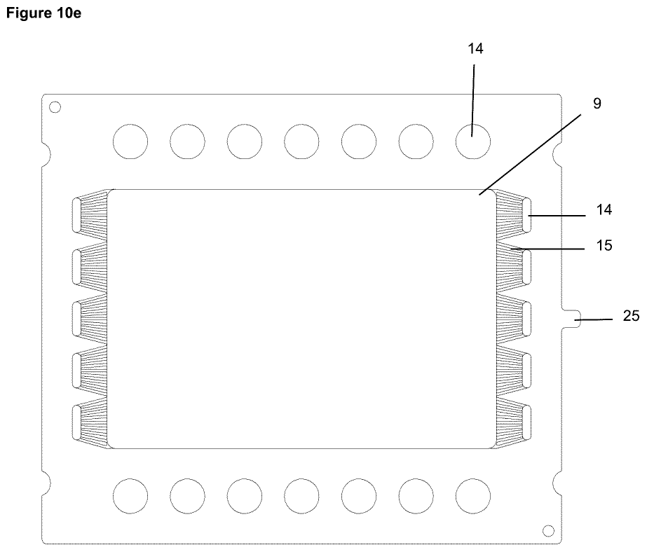

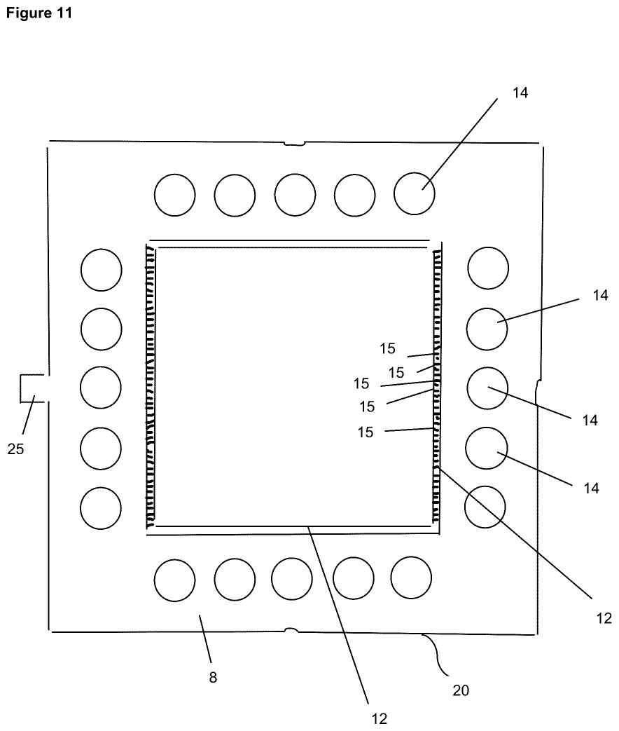

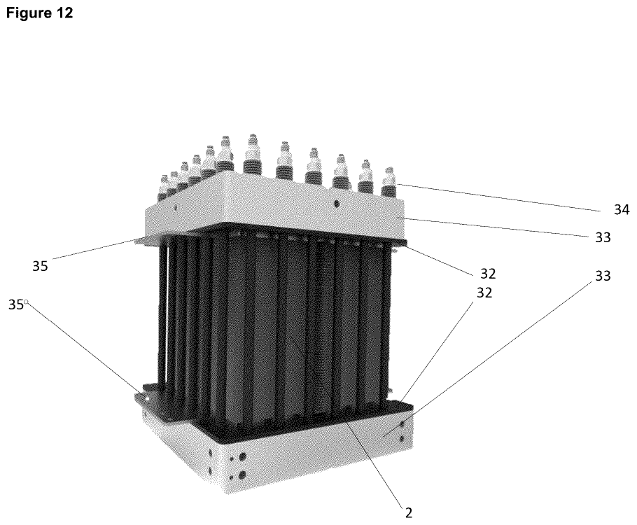

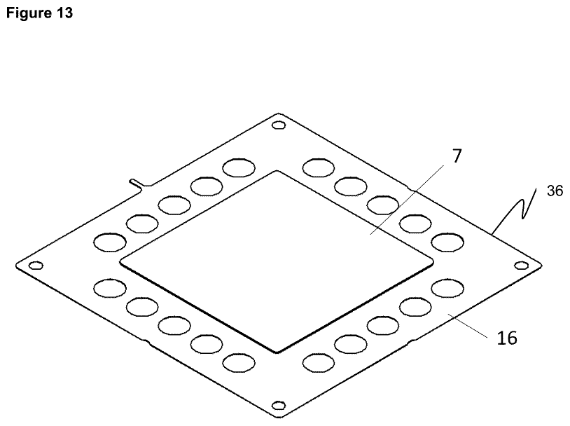

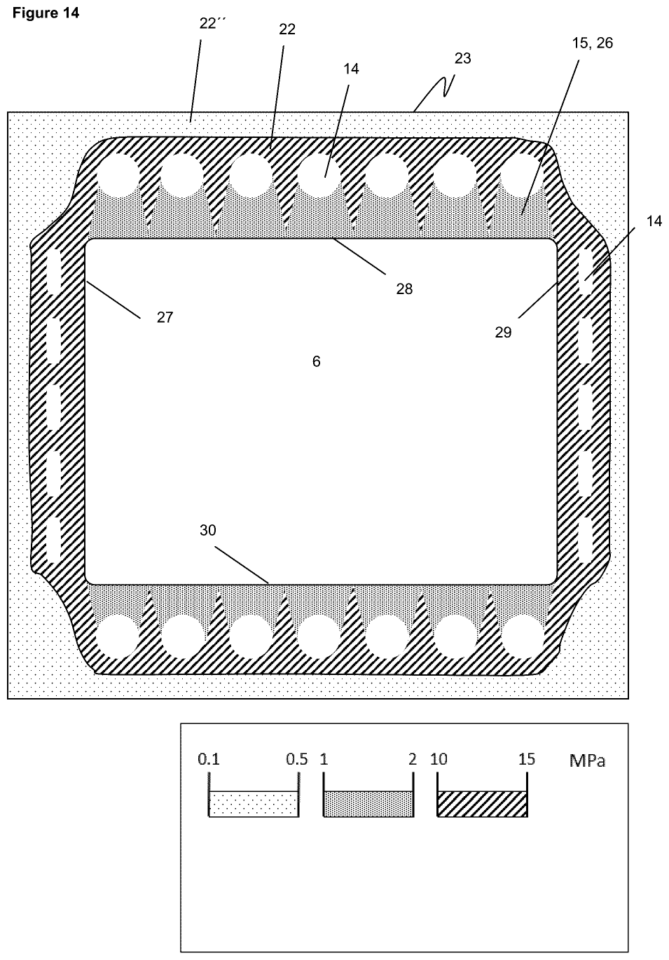

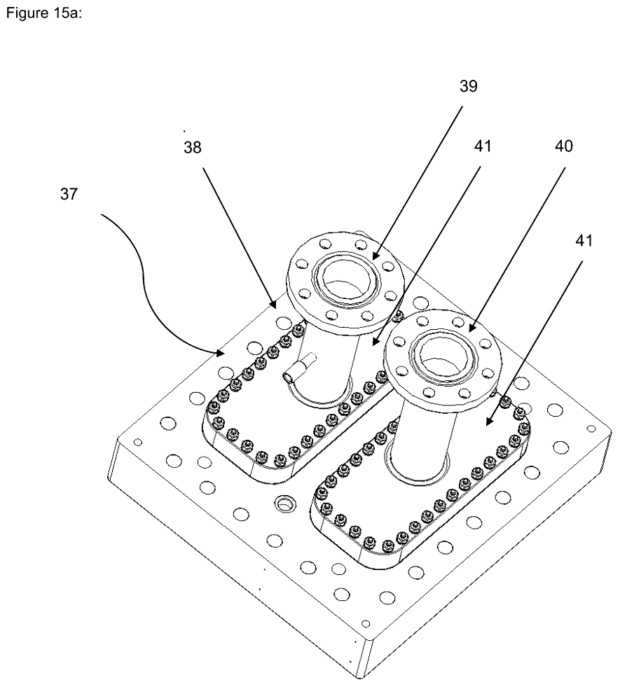

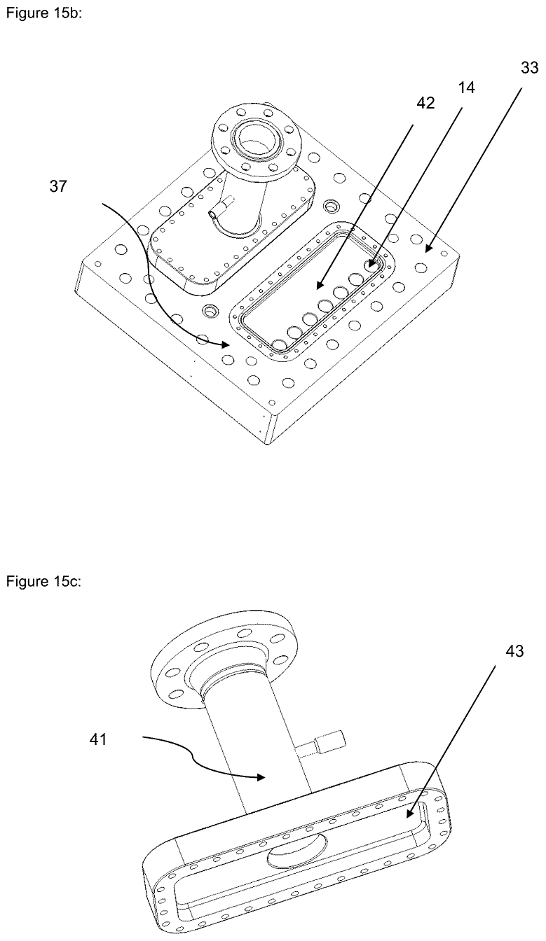

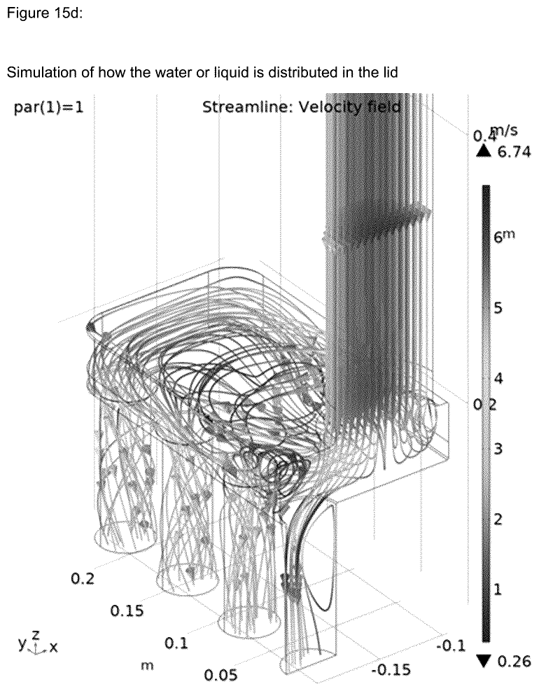

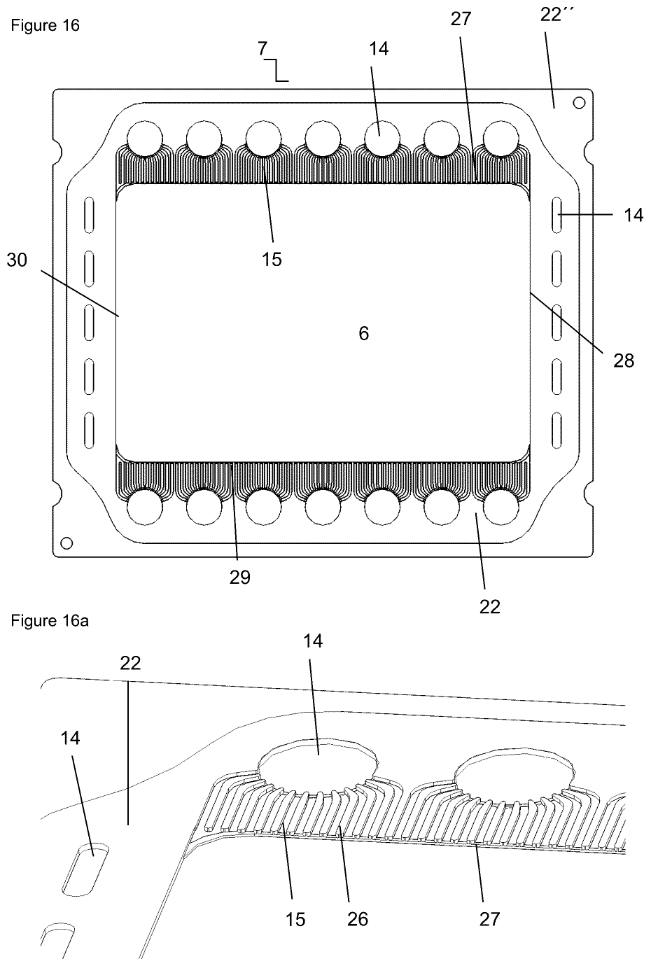

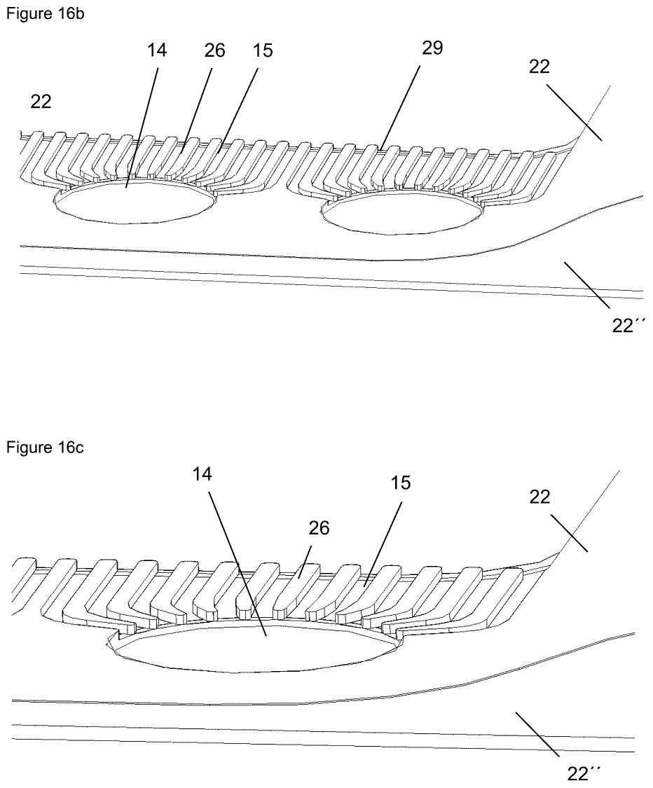

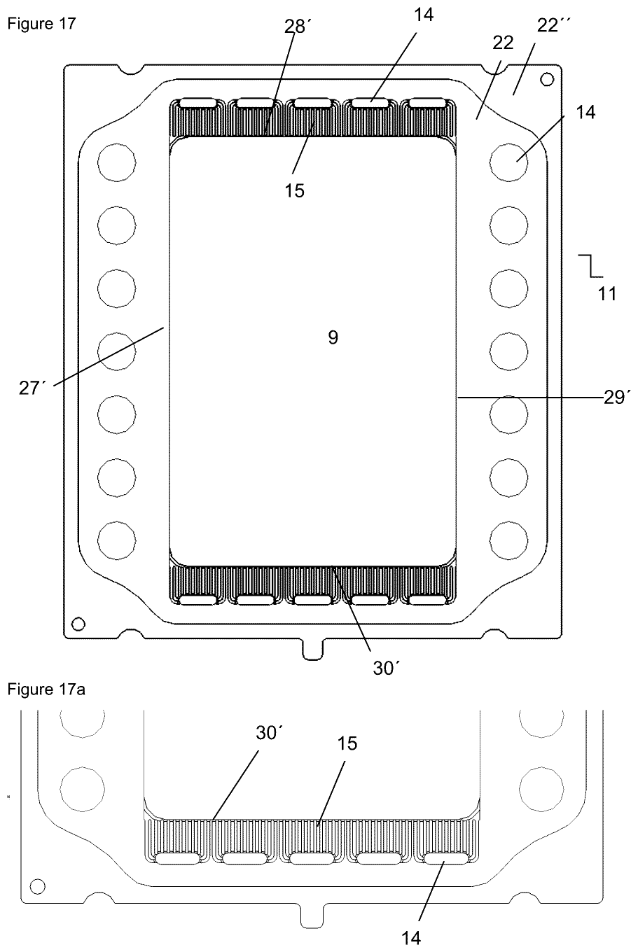

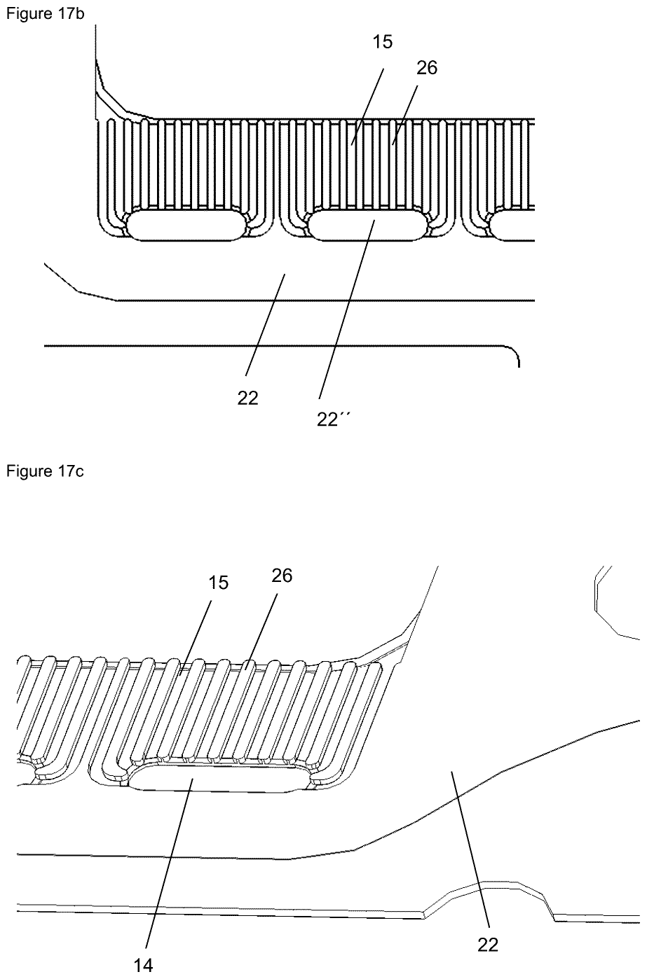

The invention claimed is:

1. A frame for a PEM electrolytic cell of a PEM electrolysis device of the stack type, the frame comprising a first side having a planar first surface and a second side opposite to the first side having a planar second surface and an anode frame and a cathode frame, and
wherein the anode frame comprises the first side, a side opposite the first side of the anode frame and a first opening for receiving the porous transport layer (PTL) anode, wherein the first opening extends from the first side to the opposite side of the anode frame,
wherein the cathode frame comprises the second side, a side opposite the second side of the cathode frame and a second opening for receiving the PTL cathode, wherein the second opening extends from the second side to the opposite side of the cathode frame,
wherein the side opposite the first side of the anode frame and the side opposite the second side of the cathode frame are arranged next to each other,
wherein the anode frame and cathode frame are connected to each other,
wherein the first opening and the second opening are connected to each other,
wherein the first opening is larger than the second opening and wherein the anode frame and the cathode frame are arranged such that the side opposite the first side of the anode frame and the side opposite the second side of the cathode frame form a step at the transition from the anode frame to the cathode frame and wherein the step forms a planar third surface as a support surface for the catalyst-coated membrane (CCM), and wherein the anode frame comprises a core and a coating made of sealing material, and wherein the cathode frame comprises a core and a coating made of sealing material.

2. The frame according to claim 1 comprising one or more channels type I for the transport of water into the frame and for the transport of water and gas out of the frame and comprising one or more channels type II for the transport of water into the first opening and for the transport of water and oxygen out of the first opening, wherein the channels type I are not connected to the first opening in the anode frame or the second opening in the cathode frame, wherein the anode frame comprises on the surface of the first side one or more channels type II which are connected to one or more channels type I and connect the channel(s) type I with the first opening and which, when the frame is installed in a PEM electrolytic cell or a PEM electrolysis device of the stack type, are arranged in the direction of the bipolar plate (BPP), and wherein the side opposite the first side of the anode frame comprises no channels type II.

3. The frame according to claim 2 comprising one or more channels type I for the transport of water into the frame and for the transport of water and gas out of the frame and comprising one or more channels type II for the transport of hydrogen out of the second opening, wherein the channels type I are not connected with the first opening in the anode frame or the second opening in the cathode frame, wherein the cathode frame comprises on the surface of the second side one or more channels type II which are connected to one or more type I channels and connect the channel(s) type I with the second opening and which, when the frame is installed in a PEM electrolytic cell or a PEM electrolysis device of the stack type, are arranged in the direction of the bipolar plate (BPP), and wherein the side opposite the second side of the cathode frame comprises no channels type II.

4. The frame according to claim 3, wherein the first opening is formed by a first side, a second side, a third side and a fourth side, and wherein for uniform flow of water through the first opening and for constant removal of the reaction heat from the first opening each channel type I, which is connected to the first opening, is connected to the first opening by means of at least two channels type II, and
the channels type II are arranged next to one another on the first side of the frame, and the distance between two adjacent channels type II on the first side of the first opening is ≤3 mm and the distance between two adjacent type II channels on the third side of the first opening is ≤3 mm.

5. The frame according to claim 4, wherein the second opening is formed by a first side, a second side, a third side and a fourth side, and wherein, for uniform flow of water through the second opening and for constant removal of the reaction heat from the second opening, each channel type I, which is connected to the second opening, is connected to the second opening by means of at least two channels type II, and
the channels type II are arranged next to one another on the second side of the frame, and the distance between two adjacent channels type II on the second side of the second opening is ≤3 mm and the distance between two adjacent channels type II on the fourth side of the second opening is ≤3 mm.

6. The frame according to claim 5, wherein the distance between adjacent channels type II on the first side of the first opening and the third side of the first opening is equal, and wherein optionally the distance between adjacent channels type II on the second side of the second opening and the fourth side of the second opening is equal.

7. The frame according to claim 6, wherein the at least two channels type II between the first side of the first opening and the channel type I which is connected to the first opening by means of said at least two channels type II, are arranged in a fan-shaped manner and the at least two channels type II between the third side of the first opening and the channel type I which is connected to the first opening by means of said at least two channels type II, are arranged in a fan-shaped manner and wherein optionally the at least two channels type II between the second side of the second opening and the channel type I, which is connected to the second opening by means of these at least two channels type II, are arranged in a fan-shaped manner and the at least two channels type II between the fourth side of the second opening and the channel type I, which is connected to the second opening by means of these at least two channels type II, are arranged in a fan-shaped manner.

8. The frame according to claim 1, wherein the core of the anode frame is made of metal and the core of the cathode frame is made of metal and wherein the coating made of sealing material that the anode frame comprises is a coating made of rubber and wherein the coating made of sealing material that the cathode frame comprises is a coating made of rubber.

9. The frame according to claim 1, wherein a part of the coating made of sealing material of the anode frame in order to reduce the contact pressure has a reduced layer thickness of the coating made of sealing material in comparison to the layer thickness of the coating made of sealing material and/or wherein a part of the coating made of sealing material of the cathode frame in order to reduce the contact pressure has a reduced layer thickness of the coating made of sealing material in comparison to the layer thickness of the coating made of sealing material.

10. The frame according to claim 9, wherein the coating made of sealing material in a part of the anode frame has a circumferential elevation 26″ in order to increase the sealing effect, wherein the circumferential elevation 26″ surrounds the first opening and/or wherein the coating made of sealing material in a part of the cathode frame has a circumferential elevation 26″ in order to increase the sealing effect, wherein the circumferential elevation 26″ surrounds the second opening.

11. The frame according to claim 1, wherein the anode frame comprises one or more connecting elements for connection to the cathode frame, and the cathode frame comprises one or more connecting elements for connection to the anode frame, wherein the connecting elements are arranged such that the anode frame and the cathode frame can be connected to each other and the hole(s) are arranged such that the hole(s) in the cathode frame are plugged onto the pin(s) in the anode frame and the anode frame and cathode frame can thereby be connected to one another.

12. A PEM electrolytic cell for operation under differential pressure of up to 40 bar for generating high-pressure hydrogen, comprising a CCM, a PTL anode, a PTL cathode, wherein the PEM electrolytic cell comprises the frame according claim 1,
wherein the first opening in the anode frame comprises the PTL anode and the second opening in the cathode frame comprises the PTL cathode and wherein the CCM is arranged between the side opposite the first side of the anode frame and the side opposite the second side of the cathode frame, wherein one side of the CCM rests on the PTL anode and the other side of the CCM rests on the step and the PTL cathode.

13. The PEM electrolytic cell according to claim 12, wherein the CCM has a thickness of less than 80 μm.

14. A pre-assembled module for manufacturing an electrolysis device of the stack type comprising an anode frame, a cathode frame, a BPP, a PTL anode and a PTL cathode,
wherein the anode frame comprises a first side with a planar first surface, a side opposite the first side of the anode frame and a first opening for receiving the PTL anode, wherein the first opening extends from the first side to the side opposite the first side of the anode frame, and wherein the first opening is framed by the anode frame, and wherein the anode frame comprises at least one connecting element,
wherein the cathode frame comprises a second side with a planar second surface, a side opposite the second side of the cathode frame and a second opening for receiving the PTL cathode, wherein the second opening extends from the second side to the side opposite the second side of the cathode frame and is framed by the cathode frame, and wherein the cathode frame comprises at least one connecting element,
wherein the BPP is arranged between the first side and the second side, wherein the anode frame comprises a core and a coating made of sealing material, the cathode frame comprises a core and a coating made of a sealing material, and wherein the PTL cathode is inserted or pressed into the second opening and is framed by the cathode frame,
wherein the connecting element of the anode frame is connected to the connecting element of the cathode frame, wherein the first opening is larger than the second opening and wherein the anode frame and the cathode frame are arranged in such a way that the first side and the second side form a step at the transition from the anode frame to the cathode frame and wherein the step forms a planar third surface as a support surface for the CCM, wherein the BPP rests on the PTL anode and the anode frame on one side and rests on the PTL cathode, the cathode frame and the step on the other side.

15. A method of manufacturing a pre-assembled module comprising the steps of
a) a core made of metal is produced for the anode frame, wherein the core comprises a first side with a planar first surface and a side opposite the first side of the anode frame, wherein the first side and the side opposite the first side of the anode frame comprise a first opening which extends from the first side to the side opposite the first side of the anode frame and which is framed by the anode frame, and wherein in the anode frame one or more type I channels for the supply and removal of water and gas are created, wherein the channels type I are not connected to the first opening in the anode frame, and wherein the anode frame comprises at least one connecting element for connection to the cathode frame,
b) all or part of the surface of the core made of metal produced according to a), is completely or partially coated with natural or synthetic rubber and subsequently vulcanized and thereby a coating made of rubber is created on the core made of metal as a sealing material, wherein in the coating made of rubber one or more channels type II are created on the surface of the first side, which are connected to one or more channels type I channels and which connect the channel(s) type I with the first opening and which, when the anode frame is installed in a PEM electrolytic cell or a PEM electrolysis device of the stack type, are arranged in the direction of the BPP, and wherein no channels type II are created in the coating made of rubber on the side opposite the first side of the anode frame,
c) the PTL anode is placed or pressed into the anode frame produced in accordance with a) and b), the PTL anode),
d) a core made of metal is produced for the cathode frame, wherein the core made of metal comprises a second side with a planar second surface and a side opposite the second side of the cathode frame, wherein the second side and the side opposite the second side of the cathode frame comprise a second opening which extends from the second side to the side opposite the second side of the cathode frame and which is framed by the cathode frame, and wherein in the cathode frame one or more type I channels for the supply and removal of water and gas are created, wherein the channels type I are not connected to the second opening in the cathode frame, and wherein the cathode frame comprises at least one connecting element for connection to the anode frame,
e) all or part of the surface of the core made of metal produced according to d) is completely or partially coated with natural or synthetic rubber and subsequently vulcanized and thereby a coating made of rubber is created on the core made of metal as a sealing material, wherein in the coating made of rubber one or more channels type II are created on the surface of the second side, which are connected to one or more channels type I and which connect the channel(s) type I with the second opening and which, when the cathode frame is installed in a PEM electrolytic cell or a PEM electrolysis device of the stack type, are arranged in the direction of the BPP, and wherein no channels type II are created in the coating made of rubber on the side opposite the second side of the cathode frame,
f) the cathode frame produced according to d) and e) is connected by means of the at least one connecting element of the cathode frame to c) by means of the at least one connecting element of the anode frame,
wherein the BPP is arranged between the first side and the second side, and the PTL cathode is inserted or pressed into the cathode frame, wherein the first opening is larger than the second opening and wherein the anode frame and the cathode frame are arranged in such a way that the side opposite the first side of the frame of the anode frame and the side opposite the second side of the frame of the cathode frame form a step at the transition from the anode frame to the cathode frame.

16. A method of manufacturing a PEM electrolysis device of the stack type for operation under differential pressure to produce high pressure hydrogen comprising the steps of,
a) at least x pre-assembled modules according to claim 14 and at least x+1 CCMs are alternately stacked on top of each other, wherein a stack of pre-assembled modules is produced, wherein in the stack of pre-assembled modules one pre-assembled module and one CCM are alternately stacked on top of each other, and wherein one CCM is arranged on the top side and on the bottom side of the stack of pre-assembled modules and one CCM is arranged between each two adjacent pre-assembled modules, and wherein
b) a half-cell anode and an anode frame are arranged parallel to an outer CCM on one side of the stack of pre-assembled modules and a half-cell cathode,
c) an end plate is arranged parallel to the half-cell anode and parallel to the half-cell cathode and the stack produced is then compressed between the two end plates to form a device of the stack type,
where x is an integer and ≥2.

17. A PEM electrolysis device of the stack type for operation under differential pressure for generating high-pressure hydrogen, comprising x pre-assembled modules according to claim 14, x+1 CCMs, a single anode, a single cathode and two end plates, wherein the x pre-assembled modules and the x+1 CCMs are stacked alternately one above the other to form a stack of pre-assembled modules, wherein one pre-assembled module and one CCM are stacked alternately one above the other in the stack of pre-assembled modules, and wherein one CCM is arranged on the top side and one on the bottom side of the stack of pre-assembled modules and one CCM is arranged between two adjacent pre-assembled modules, and wherein a single anode is arranged parallel to an outer CCM on one side of the stack of pre-assembled modules and a single cathode is arranged parallel to an outer CCM on the other side of the stack of pre-assembled modules,
wherein an end plate is arranged parallel to the single anode and parallel to the single cathode, respectively, and the generated stack is compressed between the two end plates to form a PEM electrolysis device of the stack type, wherein x is an integer and ≥2.

18. An electrolysis device of the stack type for operation under differential pressure for generating high-pressure hydrogen, comprising x+1 PEM electrolytic cells according to claim 12, comprising x+1 CCMs and x−1 BPPs, an upper end plate and a lower end plate, wherein the x+1 PEM electrolytic cells and the x−1 BPPs are stacked alternately one above the other, wherein in the stack one PEM electrolytic cell and one BPP are alternately stacked one above the other and wherein one BPP is arranged on the upper side and one on the lower side of the stack and one BPP is arranged between two adjacent PEM electrolytic cells, and wherein an upper end plate is arranged parallel to the BPP on the upper side of the stack and a lower end plate is arranged parallel to the BPP on the lower side of the stack and the stack produced is compressed between the upper end plate and the lower end plate to form a PEM electrolysis device of the stack type,
where x is an integer and ≥2.

19. The PEM electrolysis device of the stack type according to claim 17, wherein each of the x+1 CCMs in the PEM electrolysis device of the stack type has a thickness of less than 80 μm.

20. The PEM electrolysis device of the stack type according to claim 17 comprising two end plates, at least one water connection for the discharge of water and at least two distributor covers, wherein the at least one end plate for providing space for water has at least two spaces for the distribution of water in the at least one end plate and wherein each of the at least two distributor covers has space for the distribution of water in the distributor cover and wherein at least one distributor cover for the introduction of water into the PEM electrolysis device of the stack type is connected to at least one water connection for the introduction of water and a space for water distribution in the end plate, and wherein at least one further distributor cover for the discharge of water from the PEM electrolysis device of the stack type is connected to at least one water connection for the discharge of water and a space for water distribution in the end plate.

21. A Lid for a PEM electrolysis device of the stack type according to claim 17, wherein an end plate comprises at least one water connection for the introduction of water into the PEM electrolysis device of the stack type, at least one water connection for the discharge of water from the PEM electrolysis device of the stack type and at least two distributor covers, wherein the end plate has at least two spaces for water distribution in the end plate to provide space for water, and wherein each of the at least two distributor covers has space for water distribution in the distributor cover, and wherein at least one distributor cover for the introduction of water into the PEM electrolysis device of the stack type is connected to at least one water connection for the introduction of water and a space for water distribution in the end plate, and wherein at least one further distributor cover for the discharge of water from the PEM electrolysis device of the stack type is connected to at least one water connection for the discharge of water and a space for water distribution in the end plate.
